(19) United States
(12) Patent Application Publication
(10) Pub. No.: US 2023/0101696 A1
(43) Pub. Date: Mar. 30, 2023

(54) SYSTEMS AND METHODS FOR EVALUATING AUTOMATED FEEDBACK FOR GESTURE-BASED LEARNING

(71) Applicants: Ayan Banerjee, Gilbert, AZ (US); Sandeep Gupta, Phoenix, AZ (US); Sameena Hossain, Tempe, AZ (US)

(72) Inventors: Ayan Banerjee, Gilbert, AZ (US); Sandeep Gupta, Phoenix, AZ (US); Sameena Hossain, Tempe, AZ (US)

(73) Assignee: Arizona Board of Regents on Behalf of Arizona State University, Tempe, AZ (US)

(21) Appl. No.: 17/937,324

(22) Filed: Sep. 30, 2022

Related U.S. Application Data
(60) Provisional application No. 63/250,935, filed on Sep. 30, 2021.

(51) Int. Cl. G06F 3/01; G09B 21/00

(52) U.S. Cl. CPC G06F 3/017; G09B 21/009

(57) ABSTRACT

A system examines components of gestures of a gesture-based language for evaluating proper execution of the gesture, and also examines components of new gestures for evaluating lexical similarity with existing gestures of similar meaning or theme.

### CROSS-REFERENCE TO RELATED APPLICATIONS

This is a Non-Provisional patent application that claims benefit to U.S. Provisional Patent Application Ser. No. 63/250,935 filed 30 Sep. 2021, which is herein incorporated by reference in its entirety.

### FIELD

The present disclosure generally relates to feedback systems for gesture-based learning, and in particular, to a system and associated method for an automated feedback system that provides fine grained explainable feedback and presents a comparison between automated feedback and manual feedback provided by experts.

### BACKGROUND

Appropriate feedback is known to enhance learning outcomes and much research has been conducted in support of this theory. In recent years ample research has been done as well to support enhancement in computer aided learning with the help of automated feedback. In a pandemic situation like Covid-19, computer aided learning can become most beneficial. Automated feedback-based applications can also help in regular times as they take away the perils of scheduling conflicts and can provide users with self-paced learning opportunities at their convenience. However, for a less conventional learning modality, like gesture-based learning, there is not enough research done to provide such help. Automated feedback in gesture-based learning applications can enhance learning opportunities in the field of assistive technologies, combat training, medical surgery, performance coaching or applications facilitating Deaf and Hard of Hearing (DHH) education.

A mere 20% of DHH people between the ages of 18 to 44 attend post-secondary educational institutions each year with only a small subset in technical courses. While the total DHH enrollment in STEM courses for 4-year undergraduate college (17%) is nearly the same as hearing individuals (18%), only 0.19% of DHH students attend any postgraduate education as opposed to nearly 15% of hearing individuals. This results in reduced access of DHH individuals to high quality skilled jobs in the technological fields that require postgraduate education, where they may earn 31% more.

It is with these observations in mind, among others, that various aspects of the present disclosure were conceived and developed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a diagram showing a system for gesture evaluation;

FIG. 2 is a diagram illustrating a feedback generation process of the system of FIG. 1 for checking gesture execution;

FIG. 3 is a photograph showing three main concepts to be evaluated in American Sign Language (ASL) gesture execution;

FIG. 4 is a diagram illustrating a process for Comparison of Automated Feedback with Manual Feedback for evaluation of ASL gesture execution;

FIG. 5A is a graphical representation showing a match percentage of manual and automatic feedback on individual ASL concepts;

FIG. 5B is a graphical representation showing a match percentage of manual and automatic feedback on all three ASL concepts;

FIG. 6A is a graphical representation showing results where all three component matching results by gesture;

FIG. 6B is a graphical representation showing results where only two component matching results by gesture;

FIG. 6C is a graphical representation showing results where only one component matches by gesture;

FIG. 7 is a graphical representation showing second level expert agreement with automated feedback;

FIG. 8 is a diagram showing combinations of lexical concepts to describe a technical term using a new gesture;

FIG. 9 is a diagram showing combinations of lexical concepts to describe a new word using a new gesture;

FIG. 10 is a diagram showing classifications and examples of handshapes in gestures;

FIG. 11 is a diagram showing a process for evaluating new gestures with respect to existing gestures and word relationships based on lexical properties by the system of FIG. 1;

FIG. 12 is a diagram showing a gesture network graph generated by the system of FIG. 1;

FIG. 13 is a diagram showing grouping gesture nodes according to lexical features by the system of FIG. 1;

FIG. 14 is a diagram showing a gesture network graph generated manually for comparison with the gesture network graph of FIG. 12;

FIG. 15 is a diagram showing a framework for accessible DHH education using aspects of the system of FIG. 1;

FIGS. 16A and 16B are a pair of process flow diagrams showing a method for gesture evaluation by the system of FIG. 1; and

FIG. 17 is a simplified diagram showing an example computing device for implementation of the system of FIG. 1.

Corresponding reference characters indicate corresponding elements among the view of the drawings. The headings used in the figures do not limit the scope of the claims.

### DETAILED DESCRIPTION

### 1. Introduction

Real time immediate feedback is known to enhance learning by providing better engagement with learners, as is seen in a classroom environment with teachers. Applications with automated feedback, are essentially designed to mimic the prompt feedback provided by teachers in a classroom. Advances in AI have enabled these feedbacks to be fine grained and detailed. However, there can be distrust and confusion in the minds of users about the generation and effectiveness of these automated feedbacks. Even with pre-set rubrics and lack of objectivity, manual feedback remains the gold standard in learning since humans associate learning with classrooms and human teachers.

Formative assessment has been a heavily researched area for a very long time. Formative assessment allows learners to know about their mistakes that can build towards their overall understanding of the topic. This manual fine grained feedback mechanism is what has built a long-standing trust on the manual feedback by a teacher. Hence, in recent years, this learning theory has been implemented in automated feedback research. Realtime formative automated feedback offers finer details about evaluation. To engender trust, automated feedback has to instruct learners as to how the application has arrived at the result of the evaluation. Research has shown that the explainability of feedback increases their acceptability. Extensive research has also been conducted on the learners' preferences between automated and manual feedback. However, very few works have attempted to evaluate the automated formative feedback based on expert evaluation. Aspects of the present disclosure are directed to generating concept level feedback. As such, systems described herein enables novice ASL learners to view ASL gestures executed by experts, learn and practice them.

In a further aspect, one of the biggest hurdles in technical education for the Deaf and Hard of Hearing (DHH) population is communicating technical terms through gestures. Frequently, technical terms are finger-spelled, which does not convey the action or purpose related to the term. According to a recent study, DHH students demonstrated enhanced understanding of the concepts when explanations of components of a complex mechanical system were accompanied by gestures that were congruent with the actions or purpose of the components, rather than structural gestures which only conveyed the physical appearance (e.g., gestures that were based on iconicity alone). There have been several initiatives to generate a technical sign corpus for computer science (CS) including #ASLCIear or #DeafTec. These efforts enable the development of a repository of CS technical gestures and also educate DHH population. Although such initiatives are a significant step towards a solution, there are several problems: a) several CS technical terms are still finger-spelled and there is not conscious effort to generate gestures that are congruent (e.g., lexically similar) with the actions/purpose of the technical term; b) repositories are still non-curated collections of gestures, enacted by several participants, as a result (as seen from the sample dataset), the same technical term can have multiple different gesture representations; and c) there is no provision to facilitate the generation and learning of a gesture for an unseen technical term.

For faster adoption and recognition by learners, any gesture generation framework should follow the syntax of signed communication that has been established through years of interaction within the DHH population and between their hearing counterparts. In fact, a recent collaborative effort between Gallaudet University, Carnegie Mellon University, and University of Pittsburgh, has stressed the need for including American Sign Language (ASL) in Natural Language Processing research. Aspects of the present disclosure are developed in that direction and focus on codifying the syntax of ASL gestures. In addition, aspects of the present disclosure provide a system for quantifying the lexical similarity of a gesture with other gestures related to the action or purpose of a technical term.

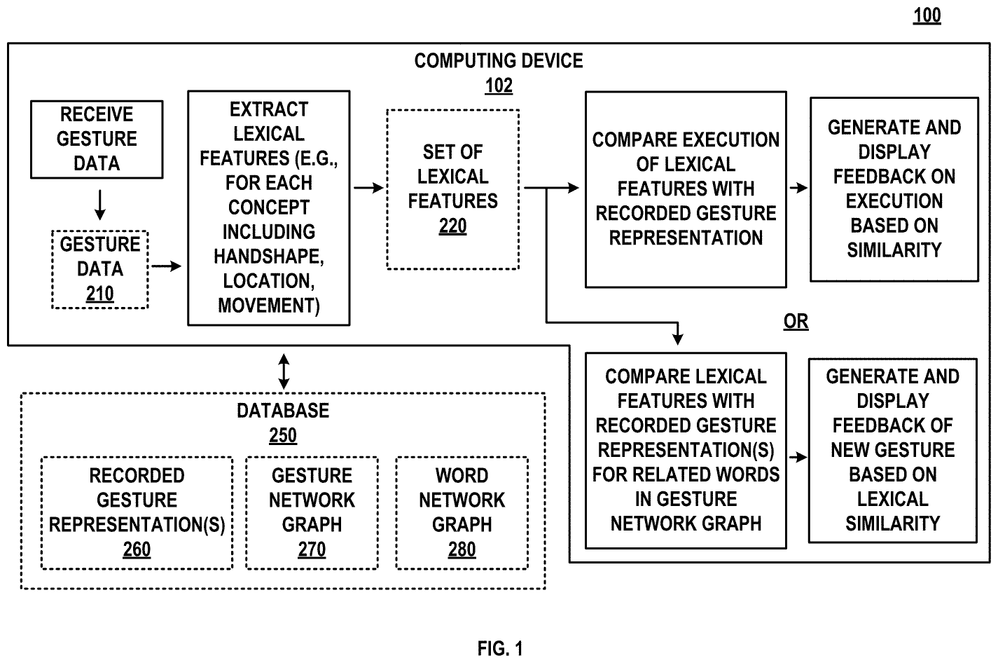

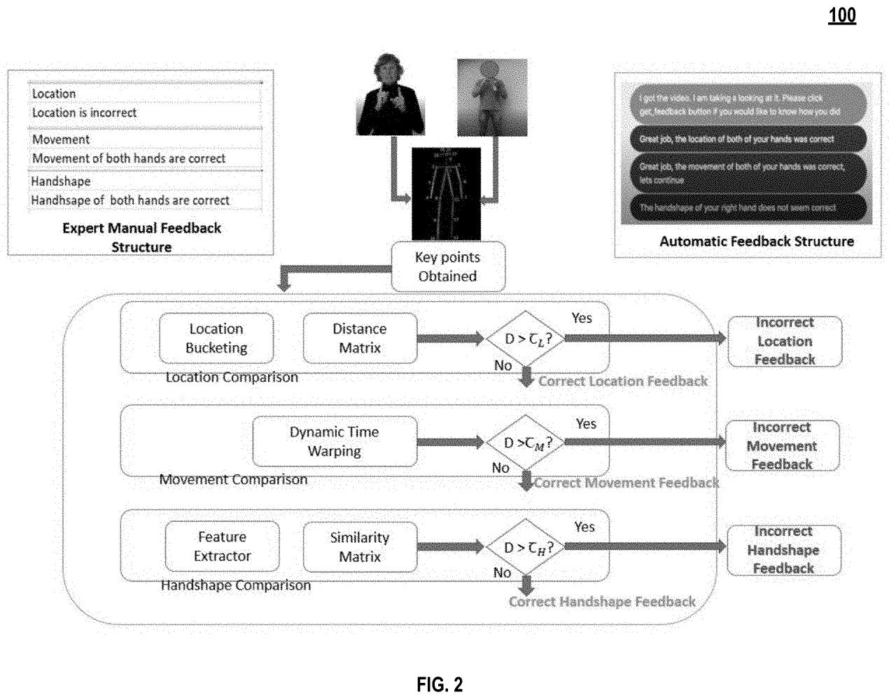

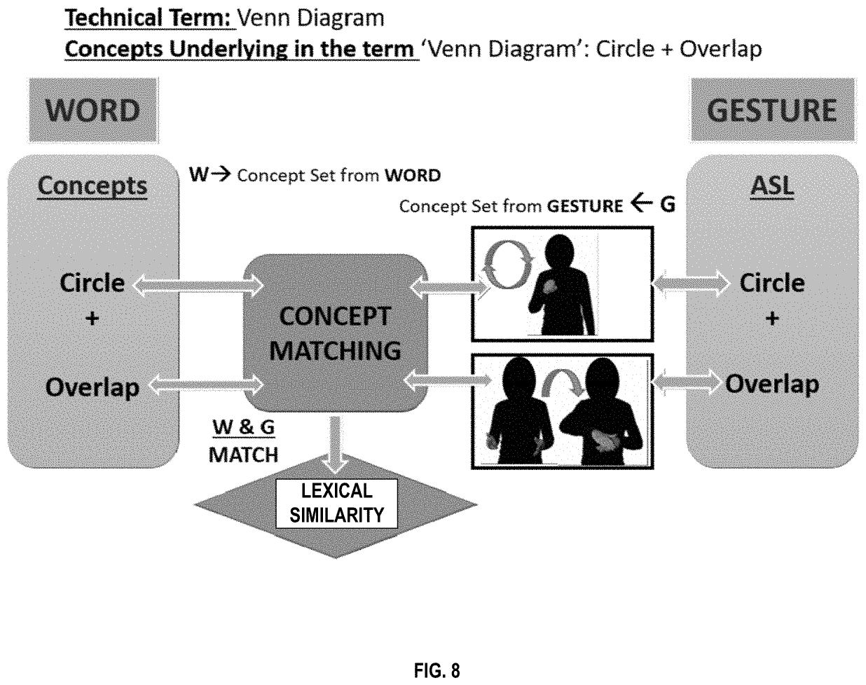

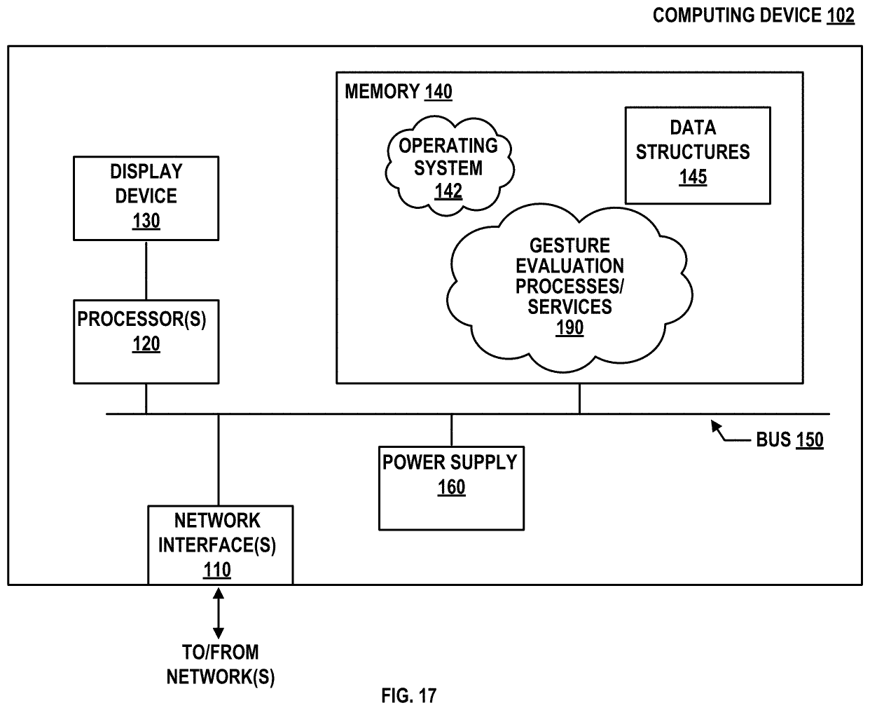

As shown in FIG. 1, a system 100 described herein examines lexical features of a gesture as executed and generates automated feedback about execution accuracy or lexical similarity of the gesture with other related gestures are described herein. In one aspect, the system 100 can be employed in an instructional setting to evaluate proper execution of the gesture in comparison to a recorded gesture representation as executed by an expert, and can provide feedback based on lexical features of the gesture (e.g., hand shape, location, and movement). This aspect of the system 100 will be discussed in sections 2-4 herein with reference to FIGS. 2-7. In a further aspect, the system 100 can use context-free grammar to model ASL syntax, and provides a lexical similarity metric to evaluate conformance of new gestures (e.g., for expression of concepts, words, or phrases that have no assigned gesture) to the ASL lexicalities. As such, the system 100 can compare gesture data with one or more recorded gesture representations of a Gesture network graph, and can also compare the gesture data and its place within the Gesture network graph with an equivalent written-language word in a Word network graph, and can provide feedback to a user based on lexical features of the gesture (e.g., hand shape, location, and movement). This aspect of the system 100 will be discussed in sections 5-8 herein with reference to FIGS. 8-15. As shown in FIG. 1, the system 100 can include a computing device 102 in communication with a database 250; the database 250 can include a plurality of recorded gesture representations 260, a gesture network graph 270, and can in some embodiments also include a word network graph 280. The computing device 102 can receive gesture data 210 indicative of a gesture, extract a set of lexical features 220 of the gesture data, and can provide feedback based on similarity of execution of the set of lexical features 220 with a recorded gesture representation 260 or can provide feedback based on lexical similarity of the set of lexical features 220 with one or more recorded gesture representations 260 for related words in the gesture network graph 270. FIG. 17 provides an illustration of the computing device 102 including a processor 120, a display device 130, and a memory 140.

It should be understood that while embodiments and examples described herein are shown with respect to American Sign Language being the gesture-based language and English being the written language, the system 100 can similarly be applied to other gesture-based languages including but not limited to Auslan (Australian sign language), German sign language, Indo-Pakistani sign language and associated sub-languages, Chinese sign language, Japanese sign language, etc., and can also be applied to corresponding written languages including but not limited to German, Hindi, Urdu, Chinese, Japanese, etc. In a further aspect, the system 100 can similarly be applied to other gesture-based communication systems such as those used in human-computer interactions, and those used in industrial settings such as factories, construction and traffic direction.

### 2. Potential Extendibility of Automated Gesture-Based Feedback

Research on automated feedback in the field of gesture-based applications is still in its infancy. Most research efforts that have been made, focus on the application of the methods of gesture recognition in different areas of learning and practice. This underexplored field of research remains underserved by lesser participation from users like Deaf and Hard of Hearing (DHH) individuals, mostly due to lack of trust. Australian researchers have explored design space for visual-spatial learning system with feedback, but they were for Auslan (Australian Sign Language) sign users and mainly focused on the feedback on location of the sign being executed and only studied learners' preferences for the presentation of the automated feedback. Some research in ASL has shown promise in the field by introducing lexical details and explainability in feedback generation to enhance learning and build trust. Unlike traditional learning applications, gesture-based applications are multimodal. Hence, errors that are present in an execution need to be tied directly to the specific component involved in the execution. There were very few research attempts to compare automated feedback on gesture execution with manual feedback from experts. For ASL Learners research has shown that students prefer visual feedback on their gesture execution, but no such research attempts were made to compare feedbacks in the field of physiotherapy, combat training or dance performance. There were no research attempts to compare gesture-based automated feedbacks with manual feedbacks on the basis of studied expert opinion. One embodiment of the system 100 generates explainable automated feedback based on the correctness of aspects of an ASL gesture including the location, movement and handshape in an ASL gesture. For validation of the system 100, the same aspects (location, movement and handshape) are used as a rubric for manual expert feedback and present a comparison between the two feedbacks based on expert opinion. The feedback generation provided by the system 100 is modeled based on recorded gesture representations from expert execution of the gestures. As such, the system 100 enables automated feedback for learners that is comparable to manual feedback and can extend its usage to other gesture-based training, e.g., robot assisted military combat, rehabilitation therapy for diseases like Parkinson's or Alzheimer's, heavy equipment operators, or for applications in coaching in performance arts. Comparable automated feedback enabled by the system 100 can help learning while social distancing or remote learning and can also help individuals who are affected by long periods of inactivity and isolation with the required training that they would need to get back to their field of work.

### 3. Providing Feedback for ASL Learners

The system 100 described herein can be employed to evaluate proper execution of a gesture as performed by an individual by comparing lexical features of the gesture as performed with a recorded gesture representation (e.g., an expert's recording of the same gesture) accessible by the processor 120 of the computing device 102 of the system 100.

In one aspect, the system 100 can maintain the recorded gesture representation as one of a plurality of recorded gesture representations within the memory 140 in communication with the processor 120 of the system 100; each respective recorded gesture representation can be associated with lexical or linguistic information such as written-language equivalent information, context or theme information, definition information, and type of word or phrase (such as part of speech or type of gesture, e.g., functional or structural). In a further aspect, each recorded gesture representation can be in the form of raw data, and/or can include lexical feature data representative of the gesture in terms of location, handshape, and movement of the gesture. Each recorded gesture representation can be indicative of proper execution of a gesture of the gesture-based language, where each gesture of the gesture-based language is analogous to a written-language word or a written-language phrase.

To evaluate proper execution of a gesture, the processor 120 can receive gesture data indicative of the gesture. This gesture data can be in the form of video data, or can be from other modalities such as Wi-Fi signal data that tracks motion; the gesture data can be obtained by observing execution of the gesture by an individual. The processor 120 can extract lexical features of the gesture data using methods outlined in greater detail below, especially location, handshape, and movement of the gesture as observable through the gesture data.

The processor 120 can compare the components (also referred to herein as lexical features) of the gesture data (for the new gesture) with lexical features of the recorded gesture representations to evaluate similarity of each respective lexical feature of the gesture data with respect to each respective lexical feature of the one or more recorded gesture representations. The system 100 can evaluate similarity of each respective lexical feature of the set of lexical features of the gesture data with respect to each respective lexical feature of a set of lexical features of the recorded gesture representation, and can generate feedback information indicative of similarity of the set of lexical features of the gesture data with respect to the set of lexical features of the recorded gesture representation. For instance, if the processor 120 identifies sufficient similarity in handshape and location of the gesture data with respect to the recorded gesture representation, then the processor 120 can provide feedback indicating proper handshape and location of the gesture. However, for example, if the processor 120 identifies insufficient similarity in movement of the gesture data with respect to the recorded gesture representation, then the processor 120 can provide feedback indicating improper movement of the gesture. Following feedback identification and generation, the processor 120 can display, at the display device 130, the feedback information indicative of similarity of the set of lexical features of the gesture data with respect to the set of lexical features of the recorded gesture representation.

In some embodiments, the processor 120 can accept information indicative of a written-language word associated with the gesture represented within the gesture data. In some embodiments, the information can indicate that the gesture data is to be compared with a recorded gesture representation for evaluation of execution accuracy of the gesture as represented within the gesture data. For instance, the information can indicate that the gesture data is to be evaluated for proper execution of an existing gesture and identifies what gesture is intended, allowing the processor 120 to check the gesture data against the expert representation (e.g., the recorded gesture representation). This information could already be available to in the processor 120 without need for input from the student (e.g., if the system 100 is configured for evaluating student execution of existing gestures in a learning environment, then the processor 120 may be configured to instruct the student which gesture to be executed).

3.1 Feedback Provided by the System

As discussed, the system 100 can be implemented as part of a self-paced gesture-based language learning application to provide context based explainable feedback to facilitate higher learning outcomes. An overview of the system 100 for evaluating execution of existing gestures is shown in FIG. 2. Users are able to perform two activities using the system 100: 1) learn ASL gestures (performed by experts) for everyday words, 2) test their knowledge by performing gestures of a given word that they have learnt. The processor 120 can compare expert gesture execution with gesture data obtained from a learner's self-recorded video and can check the gesture data for correctness. The process of comparison has the following components:

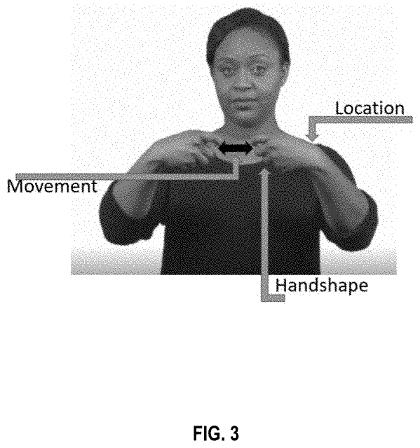

Grammar Expression of Gesture: The system 100 uses three components (also referred to herein as lexical features or lexical properties) of ASL (and other gesture-based languages) shown in FIG. 3 to examine lexical features of a gesture: location of the sign, movement, and handshape. Each gesture in ASL starts with an initial handshape and an initial location of the palm and ends with a final handshape and a final location of the palm. In between the initial handshape, location and final handshape and location, there is also a unique movement of the palm. These three components are unique concepts of a gesture since each of the handshapes, locations and movements have a specific meaning that make these gestures meaningful to ASL speakers. Gesture comparison in the system 100 is designed based on these three unique modalities of ASL gestures. The system 100 defines gesture expressions in terms of these concepts (handshape, location and movement) and are represented using context-free grammar.

Consider the Concept Set, ┌, where ┌=┌_{H} ∪ ┌_{L} ∪ ┌_{M}. Here, ┌_{H} is the set of handshapes, ┌_{L} is the set of locations and ┌_{M} is the set of movements.

So, for a regular gesture expression GE:

Handshapes (H)→┌_{H} Eqn. 1

Locations (L)→┌_{L}

Movements (L)→┌_{M}

GE→GE_{Left}GE_{Right}

GEₓ→H|Ø, where, x ∈ Right, Left

GEₓ→HL

GEₓ→HLMHL

The processor 120 is operable to provide automated feedback for execution of a gesture by evaluating correctness of these components. The correctness is determined by comparing learner's execution (as gesture data) to the execution of an expert (as a recorded gesture representation). To compare gesture data from a user with a recorded gesture representation indicative of expert execution, the processor 120 obtains, extracts, or otherwise retrieves a set of keypoints from both the recorded gesture representation (from expert execution of the gesture) and the gesture data from the learner execution of the gesture. Keypoints are the body parts that are tracked frame by frame throughout the video. Keypoint estimation is necessary to identify the location, movement and handshape of the gesture execution. In one implementation, keypoints for eyes, nose, shoulder, elbows and wrists can be collected using PoseNet.

Location Recognition: The processor 120 considers start and end locations of the hand position for pose estimation, which can in some cases be implemented using the PoseNet model or another suitable pose estimation model. The PoseNet model identifies wrist joint positions frame by frame from a video of ASL gesture execution in a 2D space for key points. The two axes, namely X-axis (the line that connects the two shoulder joints) and Y-axis (perpendicular to the x-axis), are drawn based on the shoulders of the learner as a fixed reference. The processor 120 divides the video canvas into a plurality of different sub-sections called buckets; in one implementation example, the processor 120 can consider 6 buckets. Then, as the learner executes any given sign, the processor 120 tracks location of both the wrist joints for each bucket, resulting in a vector having a length that corresponds with the number of buckets (for example, if 6 buckets are considered, then the vector length is 6). The processor 120 can follow the same procedure for the expert executions; although note that in some embodiments, the processor 120 can pre-extract and store data expressive of these aspects of the expert execution as part of the recorded gesture representation without the need for real-time processing. To compare location features of the gesture data from the learner with location features of the recorded gesture representation for the gesture as executed by the expert, the processor 120 can apply a cosine-based comparison between the two vectors to quantify similarity in location.

Movement Recognition: The processor 120 extracts movement features from gesture data by capturing the movement of the hands with respect to time from the start to the end of the sign. The processor 120 can apply a Dynamic Time Warping (DTW) technique for extracting frame-by-frame distance matrices with synchronization for the difference in speed or delayed start/stop times of the learner. This can involve application of a z-normalization methodology on the time-series for the difference in the size of the frame, distance of the learner from the camera and size of the learner relative to the tutor to some extent. DTW tries to get an optimal match for every data point in the sequence with any data point of the corresponding sequence. If a segmental DTW distance between a learner's recording and an expert recording is higher than the threshold for each arm section, this indicates a dissimilarity between movement features between the gesture as executed by the learner and the gesture as executed by the expert.

Handshape Recognition: ASL signs can differ lexically by the shape or orientation of the hands. To ensure focused hand shape comparisons and recognitions, a tight crop of each of the hands is required. The processor 120 can apply a tight crop on the gesture data using the wrist position for different videos: a) depending upon the orientation of the hands, the size of the crop was made very large relative to the learner's body and, b) the distance of the learner from the camera for the quality of the crop depending on the learner either being closer to or farther from the camera. The processor 120 uses wrist location as a guide to auto-crop these hand-shape images. During recognition time, the processor 120 extracts hand-shape images of each hand from the gesture data (from the learner's recording). Then the processor 120 passes a plurality of images for each hand (in some embodiments, 6 images total for each hand) separately through a CNN and a softmax layer and concatenates the results together. The processor 120 can apply similar processing steps on the expert video to obtain a vector of the same length; although note that in some embodiments, the processor 120 can pre-extract and store data expressive of these aspects of the expert execution as part of the recorded gesture representation without the need for real-time processing. Then, the processor 120 applies a cosine similarity on the resultant vectors to assess handshape similarity between the gesture as executed by the learner and the gesture as executed by the expert.

Automated Feedback: Based on the similarities between the recognized gesture components of experts and learners, the processor 120 provides appropriate feedback as shown in FIG. 2. The processor 120 can assess similarity based on a threshold τ, which can be predetermined (based on expert opinion) for each of the components: τ_{L} being a location similarity threshold, τ_{M} being a movement similarity threshold and τ_{H} being a handshape similarity threshold. For example, using a distance matrix, D, for location comparison, if the learner's execution is dissimilar to the expert's execution of the same gesture, the processor 120 can return a value of 1; conversely, if the learner's execution is sufficiently similar to the expert's, the processor 120 can return a value of 0. The location similarity threshold τ_{L} can be pre-decided based on an acceptable range of dissimilarity with the expert execution, that would deem the learner's execution correct. If D<τ_{L}, the processor 120 can generate and display feedback about the location to inform the user that the locations are correct; conversely, if D>τ_{L}, the processor 120 can generate and display feedback about the location to inform the user that the locations are be incorrect. The processor 120 can apply a similar process to pre-decide the handshape similarity threshold τ_{H} and the movement similarity threshold τ_{M} to generate and display appropriate feedback.

### 4. Validation Using Expert Manual Feedback

4.1 Challenges in Automated Gesture-Based Feedback

Challenge 1: Subjectivity. For a fair comparison between manual feedback and automated feedback provided by the system 100 when validating the system 100, the system 100 needs to ensure that automated feedback follows the same structure as manual feedback. Solution: In order to reduce subjectivity, the system 100 can represent an ASL gesture as a grammar-based combination of concepts (namely, location, movement and handshape). This allows the system 100 to generate concept-level formative feedback for an erroneous gesture execution.

Concept Level Formative Feedback: The system 100 can provide formative feedback for an “incorrect” gesture execution using a context-free grammar-based representation of each respective ASL gesture in terms of location, handshape and movement concepts as shown in FIG. 3. This allows learners to understand what they are evaluated on and attempts to build trust between the user and the system 100. For example, if the user exhibits the correct handshapes for both hands and the location of the hands are also correct, but the movement of the right hand is incorrect, the system 100 can examine execution of the gesture in terms of handshape, location and movement, and can generate and display feedback to the user in terms of each aspect of the gesture such as: “Location is correct, Handshape is correct, Movement of the right hand is incorrect”.

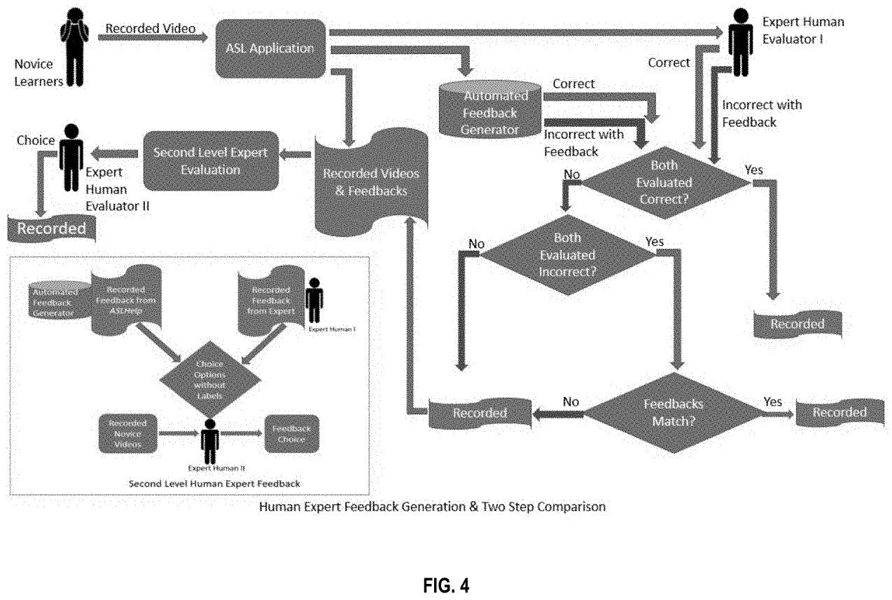

Challenge 2: Method of Comparison for System Validation. In order to compare expert manual with automated feedback provided by the system 100 for validation, the evaluation of both feedback techniques has to be performed by another ASL expert unaware of the source of feedback and the purpose of the experiment. Solution: Implement a two-step validation method shown in FIG. 4. The first validation step involves three experts who review videos of recorded gesture executions of novice learners and provide manual feedback. Automated feedback is also generated for the same videos using the system 100. Both manual and automated feedback from the system 100 are compared for each video. All feedback instances are recorded for use in the second validation step.

In the second validation step, a fourth expert is consulted who is unaware of the previous step and the purpose of the experiment. The expert is presented with two feedback choices for each gesture (from the pool of recorded automated feedback generated by the system 100 and manual feedback) for that video and is asked to choose a feedback that is appropriate for the corresponding video.

To implement the validation solutions discussed above, recorded video data was collected from experts and novice learners, collected feedback on the novice learners' videos from experts and the system 100 to perform the two step evaluation process. Details of these steps are discussed in the following subsections.

4.2 Data

Data sets were collected from two different sources: Expert Data sets from an ASL gesture website and a novice learner data set with video recordings from first time ASL Learners. The novice data set includes gesture videos from first-time ASL learners. Students learned the ASL gestures by watching expert videos. The videos were recorded by users themselves while using the system 100 in practice mode. Videos were collected from 26 learners, each performing 6 generic ASL terms. There were no restrictions on the light conditions, distance to the camera or on the position of the user while recording (standing or sitting down).

It is recognized that while expert videos are recorded in ideal conditions with proper lighting and positioning, self-recorded videos from students are not recorded in ideal condition with different items in their background and heterogenous camera use.

To reduce the subjectivity of the manual feedback when validating the system 100, a pre-set rubric is used for the feedback from the experts. The expert feedback also includes evaluation based on the location of the sign, movement and handshape. Experts use their knowledge of the gesture to evaluate the learner's execution as correct or incorrect. If the location of the sign is far off, the feedback for location is incorrect, whereas if the movement in the same execution is correct, the feedback on movement would be correct (FIG. 2). Feedback based on the incorrect movement and handshape of the right or left-hand is also provided.

4.3 Two Step Evaluation

As a solution to the Method of Comparison when validating the system 100, as mentioned above and as shown in FIG. 4, a two-step validation process is followed. First validation step is to perform a one to one comparison with feedback provided by the system 100 and the second validation step with choice options from the pool of recorded feedbacks from the first validation step.

First validation step: The first validation step is to compare feedback from the system 100 with expert feedback for the same videos showing gesture execution. The expert feedback and system-provided feedback are compared to check whether the feedbacks match. Based on the comparison, there can be six combinations:

C_{A} & C_{E};

I_{A} & C_{E};

C_{A} & I_{E};

I_{A} & I_{E} with F_{A} ∩ F_{E}=F_{A} or F_{E};

I_{A} & I_{E} with F_{A} ∩ F_{E}=F_{M};

I_{A} & I_{E} with F_{A} ∩ F_{E}=Ø;

where for the system 100, correct feedback is C_{A} and incorrect is I_{A}. For experts, correct feedback is C_{E} and incorrect is I_{E}. F_{A} represents the feedback provided by the system 100, F_{E} is expert feedback and F_{M} is one or more matched feedback. All feedback is analyzed and recorded to be used in the second step.

Second validation step: Another expert is brought in, who is unaware of the first step and the comparison process and second level of evaluation is performed using the same videos. The expert is provided with two feedback choices and asked to choose which is correct for the video. The feedback choices are provided from recorded feedback from the system 100 and experts in the first step. Second level expert choice is then recorded and analyzed.

4.4. Automated Feedback Results & Analysis (for Gesture Execution Feedback)

Execution results of the two-step expert opinion-based evaluation process to compare automated and manual expert feedback are disclosed herein. The first validation step is a one to one comparison between automated feedback provided by the system 100 and manual feedback for 154 novice learner videos. The second validation step utilizes expert opinion to evaluate the appropriateness of the feedbacks from the first step.

4.4.1 First Step: Automated Vs. Manual

3 componential 154 feedback examples each were collected from the system 100 and expert evaluators. As mentioned in section 4.3, correct feedback for all 3 components from the system 100 is labeled C_{A}, from experts as C_{E}. Feedback with any incorrect component was labeled I; I_{A} for ASLHelp and I_{E} for expert. Results from C_{A} & C_{E} and I_{A} & I_{E} with F_{A} ∩ F_{E}=F_{A} or F_{E} are most interesting, because these two combinations present the results when both feedback match exactly (100% match), regardless of the videos being labeled correct or incorrect.

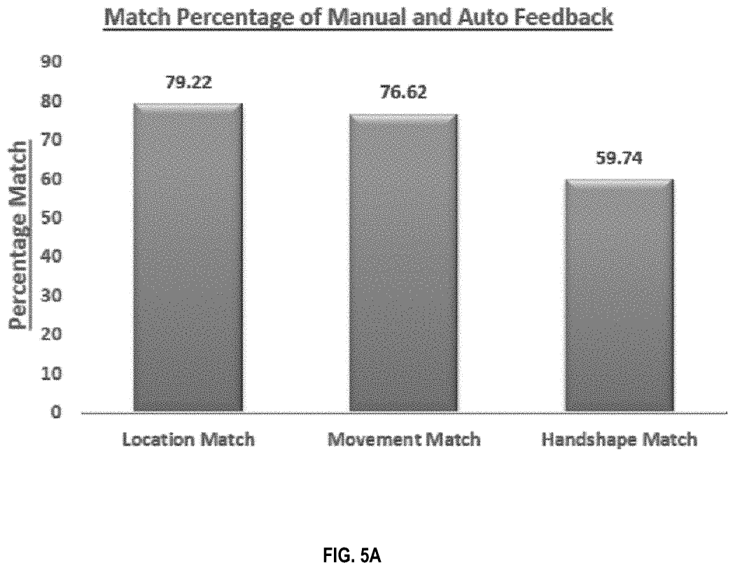

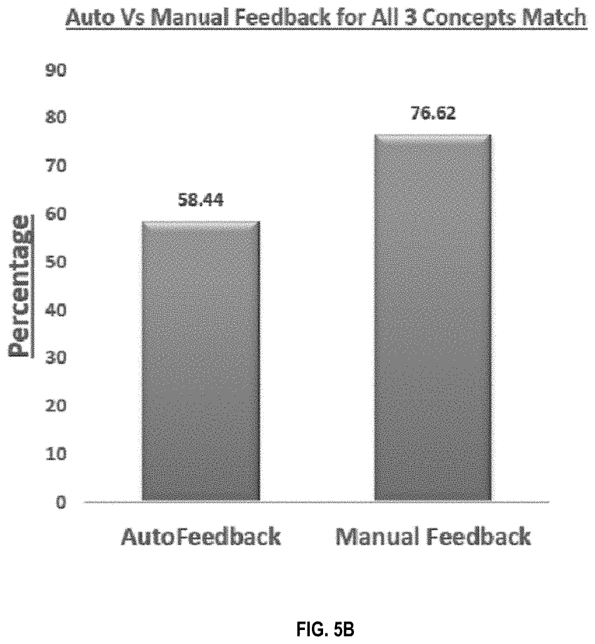

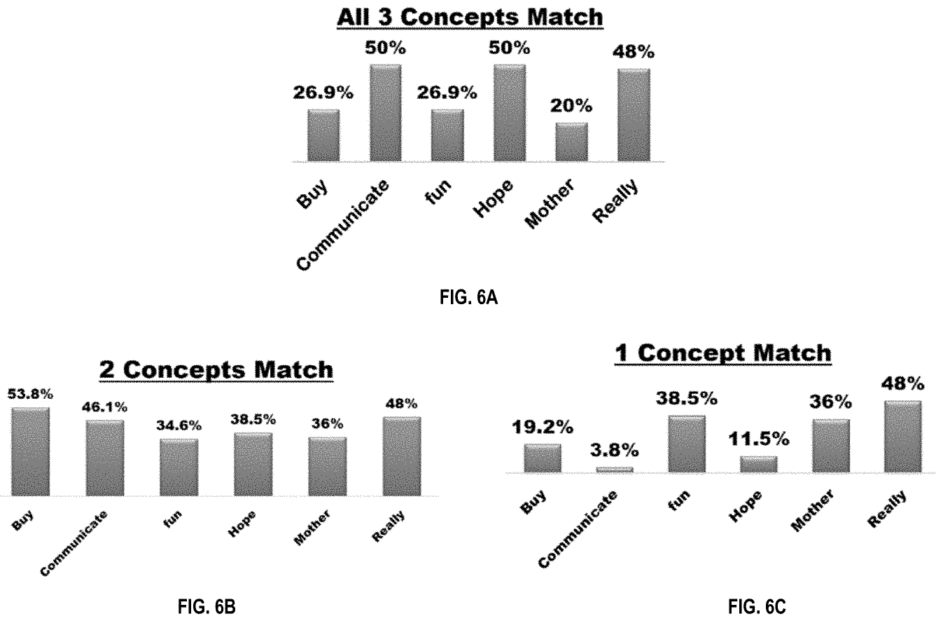

For the 3 componential feedback the categories for matching would be 100%, 66%, 33% or no match. Table 1 shows that for 57 of the videos there was a 100% feedback match. A 66% match represents only 1 mismatch between the feedbacks in the detailed feedback category. It was found that 78.87% of the times the feedbacks have only one mismatch, 98.70% of the times they agree on at least one component of the feedback and only 1.29% of the times there is no match between them as shown in Table 1. FIG. 5A shows that while the feedback from the system 100 and manual feedback for location and movement match each other respectively 79.22% and 76.62% of the times, there are more disagreements for handshape, (59.74% match). FIG. 5B shows that automated feedback from the system 100 identifies gestures to be correct on all three components 58.44% of the times while manual feedback identifies the same gestures to be correct on all components 76.62% of the times. The results were further isolated for matched feedbacks for each of the gestures, by three components, two components and one component matching (as shown in FIGS. 6A-6C).

TABLE 1
Combinations of Feedback Matching with Results

| Feedback Matching | Total | Percent |
|---|---|---|
| 100% match (C_{A} & C_{E} and I_{A} and I_{E} with | 57 | 36.25% |
| F_{A} ∩ F_{E} = F_{A} or F_{E}) | | |
| ≥66% match (I_{A} & C_{E} and C_{A} & I_{E}) | 123 | 78.87% |
| ≥33% match (I_{A} & I_{E} with F_{A} ∩ F_{E} = F_{M}) | 152 | 98.70% |
| no match (I_{A} and I_{E} with F_{A} ∩ F_{E} = ∅ | 2 | 1.29% |

4.4.2 Second Step: Second Level Expert

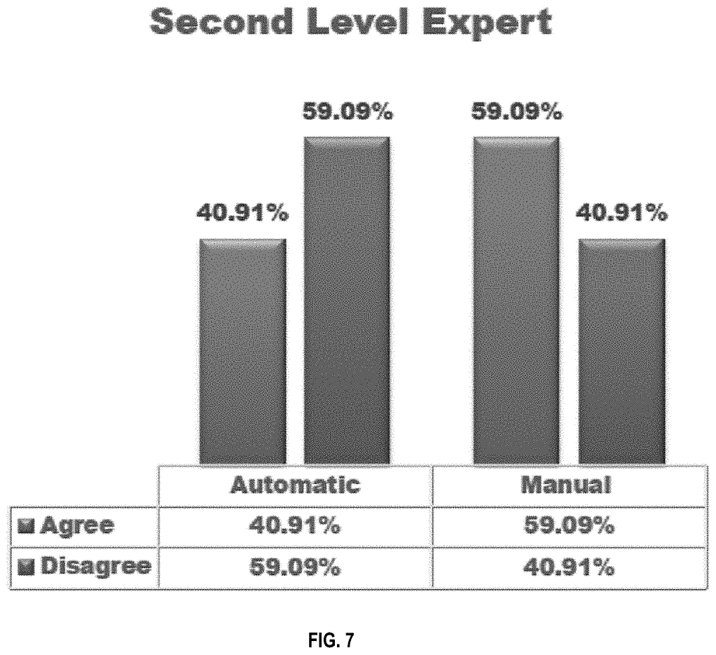

In this step, feedback from the system 100 and manual feedback from first step are evaluated based on an expert opinion. FIG. 7 shows that 59.09% of the times the expert agreed with the manual feedback and 40.91% of the times they agreed with the feedback from the system 100.

4.4.3 Analysis of the Results

The results in the first step reflect that feedback from the system 100 and manual feedback matches about ⅓ of the time. The matching is brought down significantly by the mismatched feedbacks for handshape. Feedback from the system 100 and manual feedback matches most of the time on the location and movement components. The disparity in the handshape feedback could be the result of two very different conditions that novice and expert videos are recorded in, and applications ability to identify finer details in a handshape execution. Given the imperfect conditions, heterogeneous modes of recording and backgrounds with various objects in the videos of novice learners, handshape of the gesture may not be as clear as the handshape in expert videos that are recorded in near perfect condition with no obstructive objects. This result is indicative of a required improvement in the handshape recognition mechanism of the system 100. In second step, expert has agreed with the manual feedback more times than with feedback from the system 100. This agrees with the findings in the first step and is reflective of the fact that manual evaluation is less sensitive than the system 100. However, expert has also chosen the feedback from the system 100 40.91% of the times over the manual feedback, reflecting that nearly half of the time, feedback from the system 100 was more appropriate. The comparison between feedbacks for all three components being identified as correct (FIG. 5B) also shows that the system 100 is able to pick up on finer details in the videos than experts and hence can contribute to better performance in execution of the gesture. This is believed to add value to the extendibility of such feedback from the system 100 to various other gesture-based learning applications in different fields.

5. Automated Feedback Based on Lexical Similarity

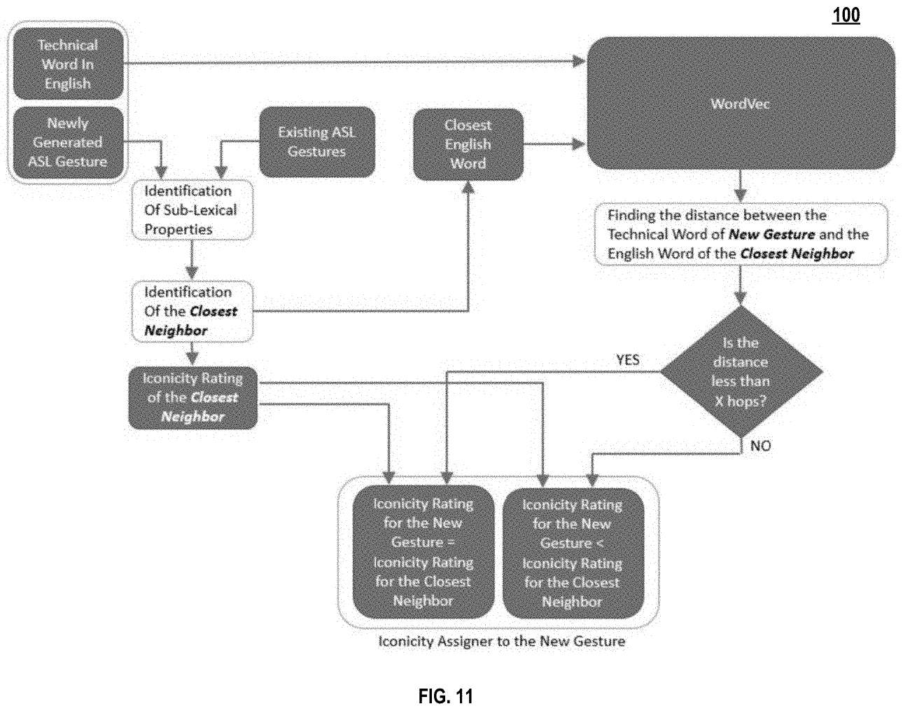

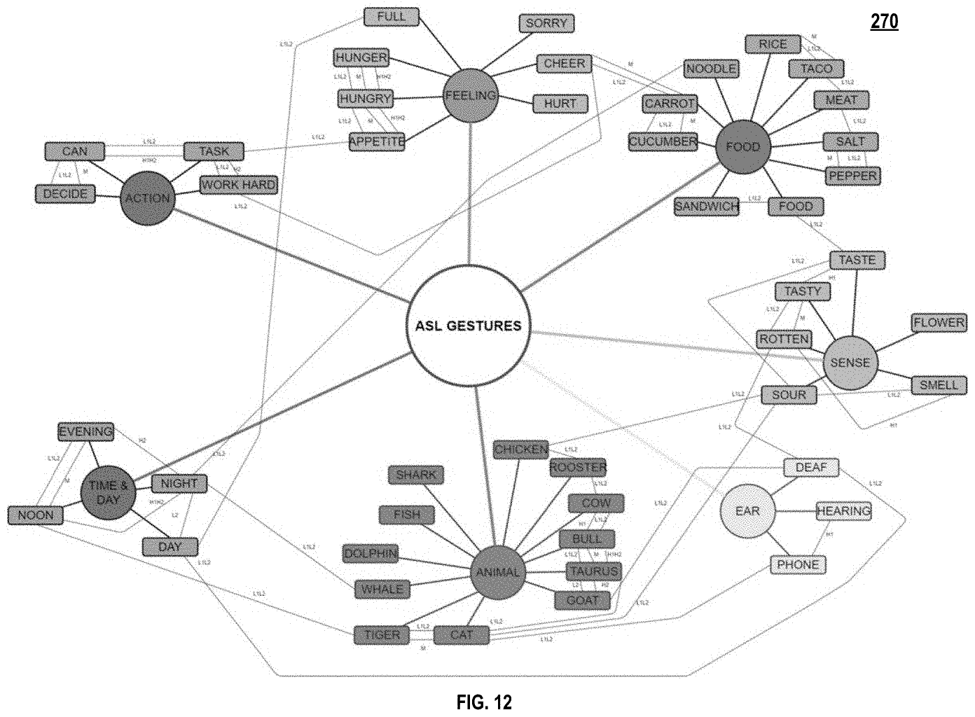

In another aspect, referring to FIG. 11 and with additional reference to FIG. 1, the system 100 can also be employed to aid in generation of gestures that conform to the syntax of a gesture-based language such as American Sign Language (ASL) and are congruent with the meaning of a word or phrase, such as a technical term. In some embodiments, the system 100 can examine lexical similarity of a new gesture with other related gestures, and can provide feedback about the new gesture based on lexical similarity with respect to other existing gestures within a gesture-based language. Such a use case would include generation of new gestures for communication of concepts where a gesture is not currently available, such as for technical concepts. As such, the system 100 can be operable to evaluate “new” gestures in terms of their lexical similarity with other gestures represented within a gesture network graph (FIG. 12) and can evaluate the localization of the new gesture within the gesture network graph compared with a written-language equivalent represented within a word network graph, (e.g., the system 100 can evaluate the new gesture in terms of its lexical similarity to an equivalent word network graph representation of the new gesture based on proximity/clustering) and can provide feedback based on evaluation of lexical similarity.

The present disclosure describes a lexical similarity metric employed by the system 100 to aid in generation of new gestures conforming to the syntax of ASL (or another gesture-based language) while being congruent with the meaning of the technical word. The present disclosure also provides information about usage and validity of the lexical similarity metric by validating the gesture network graph (with respect to the word network graph having written-language equivalents of gestures represented within the gesture network graph) of 70 ASL gestures. The present disclosure also shows that the lexical similarity metric can distinguish between action gestures and structural gestures in the ASL corpus. The lexical similarity metric will not only help develop a new technical word corpus that is acceptable to DHH learners but will also promote generation of gestures that are congruent to the action/purpose of a technical term. The latter can also be used by hearing population as visual aid to improve understanding of complex concepts in computing education. This section defines lexical similarity in terms of ASL and discuss the underlying concepts in an ASL gesture; although note that these concepts can be similarly extended to other gesture-based languages and other written languages.

5.1 Word-Gesture Lexical Similarity for Creating New Gestures

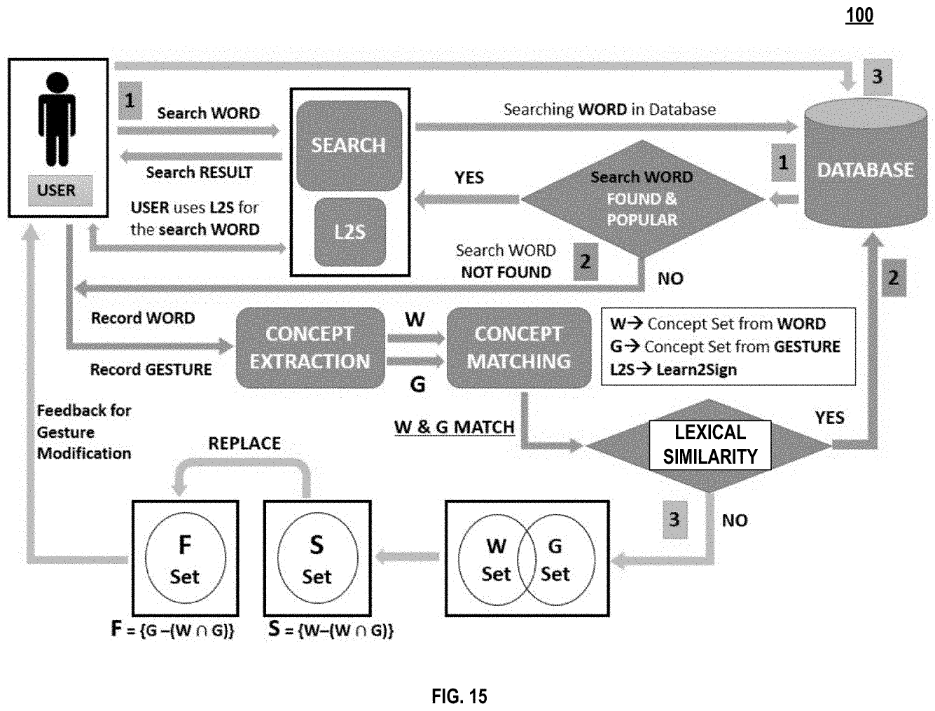

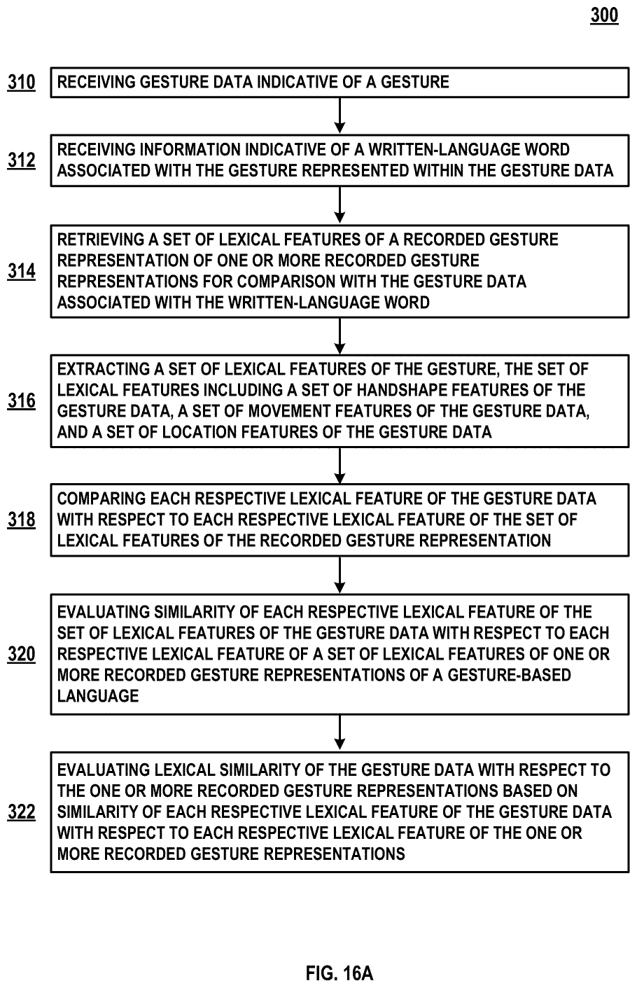

Traditionally, when a gesture is not available for a certain word, a skilled ASL user can make up a gesture that can represent the concepts associated with the word. A DHH individual can collaborate with her interpreter to assign an ad-hoc gesture for CS technical term for which no ASL sign exists. In some embodiments, the system 100 can be extended to generate gestures (FIG. 15, which will be described in greater detail in a later section) that mimics this traditional process. For example, the word ‘Venn Diagram’ (FIG. 8), is a mathematical term that has no sign available in the CS technical term repository. A suggested gesture can combine two concepts related to the word Venn Diagram: a) gesture for circular shapes, followed by b) gesture for overlap. The resulting combined gesture is lexically congruent with the word Venn Diagram. The present disclosure explores the concept of Lexical Similarity used in Linguistics and defines Lexical Similarity as referring to common gesture concepts executed for words with similar or related meaning.

5.2 ASL Word Syntax: Gesture Expression in Terms of Concepts

A Concept Set for a gesture-based language such as ASL can be built based on three unique modalities of ASL gestures: 1) location, 2) movement and 3) handshape. Consider the Concept Set, ┌, where ┌=┌H^{∪}_{┌L}^{∪}┌M. Here, ┌H is the set of handshapes, ┌L is the set of locations and ┌ₘ is the set of movements.

5.2.1 Word-Gesture Network Graph

With reference to FIGS. 1 and 11-13, the processor 120 can receive, include or otherwise access a gesture network graph 270 accessible by the processor 120 that includes representations of gestures as gesture nodes, and gesture edges (e.g., connections) between gesture nodes of the gesture network graph 270 indicate similar meanings. The processor 120 can also receive, include or otherwise access with a word network graph 280 accessible by the processor 120 that includes representations of words as word nodes, and word edges (e.g., connections) between word nodes of the word network graph 280 indicate similar meanings. Gesture nodes and (written language) word nodes that represent the same word can have the same or similar locality, proximity, and/or clique within the gesture network graph and the word network graph; as such, the gesture network graph 270 can enable a visual representation of similarities that already exist in established ASL gestures. Identifying these similarities can provide the building blocks for new standardized gestures that are lacking in technical education.

5.2.2 Lexically Relevant Concept Extraction in ASL

The system 100 enables expression of a gesture as a temporal sequence of components or concepts as represented within a gesture representation. A concept in a gesture can be defined as an indivisible component that has a lexical association with an object, a body part, action, or a physical space in any sign language. In ASL, (FIG. 3) there are three unique components (also referred to as lexical features or lexical properties) related to handshape, location of the palm, and movement of the palm in each hand. Any gesture in ASL can be expressed as a unique combination of these three types of concepts (e.g., as a context-free grammar combining these components). In ASL, commonality of these concepts may indicate similarity in lexicality.

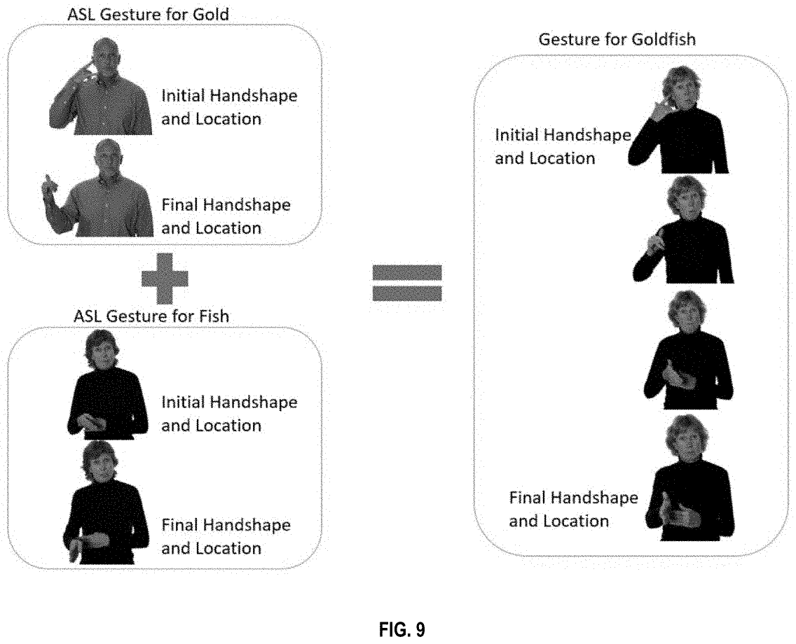

For example, the handshape used for “Goldfish” in ASL first starts off with the handshape for “Gold” and then changes into the handshape for “Fish” (as seen in FIG. 9). The handshape and movement for the gesture “Father” are the same as that of “Mother”. However, the location for “Father” is near the head while that of “Mother” is near the chin. In fact, this difference in location indicates the lexicality of gender in ASL words. Hence, the ability to express a gesture as a temporal sequence of concepts (handshape, location, and movement) helps in identifying the lexical commonality in different gestures. The system 100 uses this temporal sequence of concepts to identify lexical similarity between gestures in ASL.

Action and Structure gestures in ASL: In ASL, gestures can be categorized into: a) action (or functional), which represent the action or purpose of the word such as “food”, where the eating action is performed or “dolphin” or “fish”, where the movement of a dolphin is replicated, or b) structural, which represent some physical characteristics of the word, such as “cow”, with the hands and fingers or “bull”, where the horns of the animal is gestured with fingers. Action gestures have a distinct movement pattern, while structural gestures rely more on handshape.

With reference to FIG. 11, the processor 120 can receive the gesture data indicative of a newly generated ASL gesture and information indicative of the written-language equivalent and can compare the gesture data with existing ASL gestures to identify sub-lexical properties (e.g., lexical features or concepts including handshape, location, and movement) for the newly generated ASL gesture and for existing gestures. The processor 120 can use WordVec or another suitable methodology to identify a position in the word network graph that the written-language equivalent of the new gesture belongs. The processor 120 can identify a closest neighbor gesture of the new gesture based on the lexical features of the and identify a closest written-language equivalent of the new gesture based on the lexical features, and can assess an iconicity rating of the closest written-language equivalent. The processor 120 can then find a distance between the written-language equivalent of the new gesture (expressive of an intent of the new gesture) and the closest written-language equivalent of the new gesture as identified based on the lexical features. The processor 120 can assign an iconicity rating for the new gesture based on the distance between the written-language equivalent of the new gesture as identified by the user and the closest written-language equivalent of the new gesture as identified based on the lexical features (can be expressed as “hops” or another similarity/proximity metric). To assess whether the new gesture best captures the meaning of the written-language equivalent, the processor 120 can evaluate the iconicity rating for the new gesture with respect to the iconicity rating of the closest written-language equivalent. If the iconicity rating for the new gesture is above a threshold, then the processor 120 can consider the new gesture as being lexically similar enough to become a standardized gesture for the word. As such, the processor 120 considers the lexical properties of related gestures as well as the position of the new gesture within the gesture network graph with respect to a position of the written-language equivalent within the word network graph.

5.2.3 Objective Metrics for Lexical Similarity

A list of 200 ASL words was surveyed to create the concept set ┌_{H}, ┌_{L} and ┌_{M}. Each concept in the handshape, location, or movement set is numbered using symbols Hᵢ, Lᵢ or Mᵢ, respectively.

Concept Identity Metric: Given a gesture Gᵢ, the concept identity is a string in the context-free grammar of Eqn. 1 that expresses the gesture in ASL. For example, the concept identity metric for the ASL gesture for “Father” can be expressed as H₈L₁M₃H₈L₁.

Concept Difference Score: Given two gestures Gᵢ and Gⱼ, the concept difference score σ(Gᵢ, Gⱼ) is a function that is evaluated as follows:
1. Set σ(Gᵢ, Gⱼ)=0
2. For each terminal symbol in the gesture expression following Eqn 1, if they are different for Gᵢ and Gⱼ then σ(Gᵢ, Gⱼ)=σ(Gᵢ, Gⱼ)+1.
3. σ(Gᵢ, Gⱼ)=σ(Gᵢ, Gⱼ)/N, where N is the number of terminals in the gesture expression for the given language.

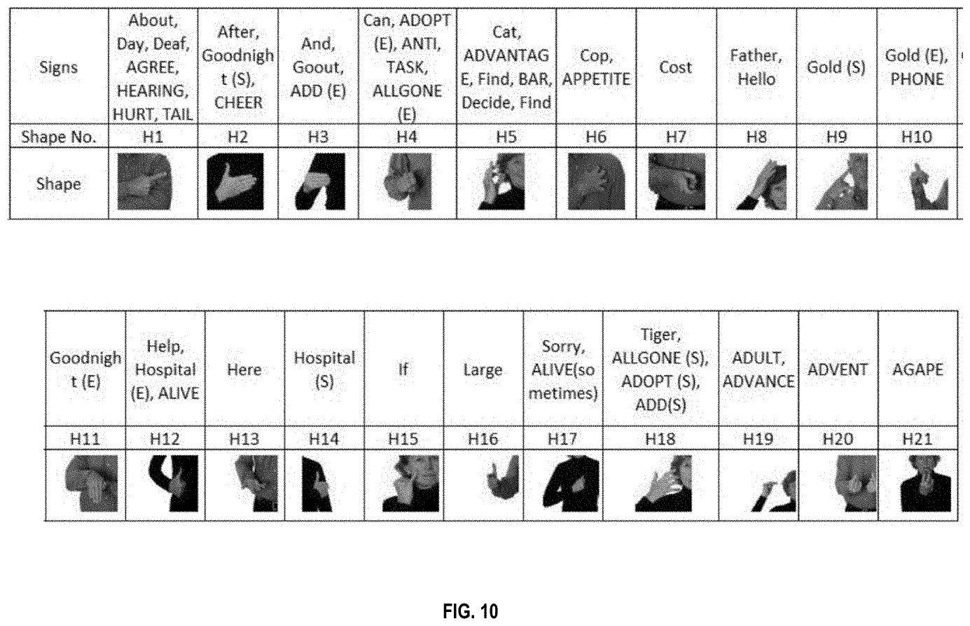

Concept Difference Score computation example: Consider two ASL gestures for “Father” and “Mother”. The concept identity for “Father” can be expressed as H₈L₁M₃H₈L₁, and “Mother” can be expressed as H₈L₄M₃H₈L₄ (as seen in FIG. 10 and in Table 2). Hence the concept difference score σ(Father, Mother)=0.4. In another example, the concept identity of Phone is H₁₀L₀M₃H₁₀L₀. The concept difference score σ(Father, Phone)=0.8 much higher than the difference between Father and Mother. This metric thus can potentially capture differences in concepts between two gestures.

TABLE 2

| | Signs | | | | | | | |
|---|---|---|---|---|---|---|---|---|
| | ADD, ADVANTAGE, | ADOPT, | | Cat, Cop, | | | | |
| | AGAPE, AGREE, | ADULT, | | Deaf, Father, | | | | |
| | APPETITE, Can, | ADVANCE, | ALLGONE, | HEARING, | | | | |
| | Cost, Decide, | ADVENT, | And, BAR, | If, PHONE, TAIL, | | | | |
| | HURT, Goodnight | ALIVE, Help | Large | TASK, Tiger | Day | About | After | ANTI |
| Movement No | M0 | M1 | M2 | M3 | M4 | M5 | M6 | M7 |
| Movement | Down | Up | Sideways | Stationary | Across | Circling | Down | Up and |
| Description | | | | Tap | | | and Up | Shake |

| | Signs | | | | | | | |
|---|---|---|---|---|---|---|---|---|
| | CHEER | Find | Goout | Gold | Hello | Here | Hospital | Sorry |
| Movement No | M8 | M9 | M10 | M11 | M12 | M13 | M14 | M15 |
| Movement | Up and | Wrist | Lateral | Shaking | Move right | Shake | Make a | Move |
| Description | Down | Rotation | Sideways | and away | arm from | horizontally | complex | right arm |
| | Twice | up | | from body | head away | | right arm | in a |
| | | | | | from the | | movement | circular |
| | | | | | body in a | | across the | motion. |
| | | | | | diagonal | | body | |
| | | | | | fashion | | | |

Gesture network graph Δ: The gesture network graph (as shown in FIG. 12) can be stored within the memory 140 in communication with the processor 120 and can be represented within the memory 140 as an un-directed graph that expresses the lexical relations between a set of words by evaluating similarity in their concept identity. Each gesture (representative of a word) is represented within the gesture network graph as a gesture node, which can be associated with a recorded gesture representation; the gesture network graph can include a plurality of recorded gesture representations for existing gestures. There can be three types of gesture edges between any two gesture nodes: a) hand-shape edge, which denotes similarity in the initial or final handshape between the two gesture nodes, b) location edge, which denotes similarity in the initial or final location between two gesture nodes, and c) movement edge, which denotes similarity in movement. The edge set of the gesture network graph can be expressed using three upper-triangular adjacency matrices: A_{H}, for handshape edge, A_{L}, for location, and A_{M} for movement. The entries are either 1 when the concepts match between the gestures, or 0 if they do not.

Lexical similarity score ω: The lexical similarity metric is defined to evaluate lexical grouping of words by two different agents. The processor 120 can employ the lexical similarity metric to compare lexical groupings within the gesture network graph with one another and can use the lexical similarity score to identify a locality within the gesture network graph that a new gesture belongs in. During validation, the lexical similarity score is used to compare lexical groupings obtained from an expert with lexical groupings obtained by the system. Given two gesture network graphs Δ₁ with adjacency matrix {A_{H}¹,A_{L}¹,A_{M}¹} and Δ₂ with adjacency matrix {A_{H}²,A_{L}²,A_{M}²} the lexical similarity score is defined by Eqn 2.

$$ω ( {Δ}_{1} , {Δ}_{2} ) = \frac{{\sum }_{i}^{N} {\sum }_{j = i}^{N} \vert ( {a}_{L}^{1} ( i , j ) - {a}_{L}^{2} ( i , j ) ) \vert}{{\sum }_{i}^{N} {\sum }_{j = i}^{N} \vert ( {a}_{L}^{1} ( i , j ) - {a}_{L}^{2} ( i , j ) ) \vert} + \frac{{\sum }_{i}^{N} {\sum }_{j = i}^{N} \vert ( {a}_{H}^{1} ( i , j ) - {a}_{H}^{2} ( i , j ) ) \vert}{{\sum }_{i}^{N} {\sum }_{j = i}^{N} \vert ( {a}_{H}^{1} ( i , j ) - {a}_{H}^{2} ( i , j ) ) \vert} + \frac{{\sum }_{i}^{N} {\sum }_{j = i}^{N} \vert ( {a}_{M}^{1} ( i , j ) - {a}_{M}^{2} ( i , j ) ) \vert}{{\sum }_{i}^{N} {\sum }_{j = i}^{N} \vert ( {a}_{M}^{1} ( i , j ) - {a}_{M}^{2} ( i , j ) ) \vert} \qquad ( 2 )$$

5.2.4 Identifying Congruent Clique for a Given Gesture

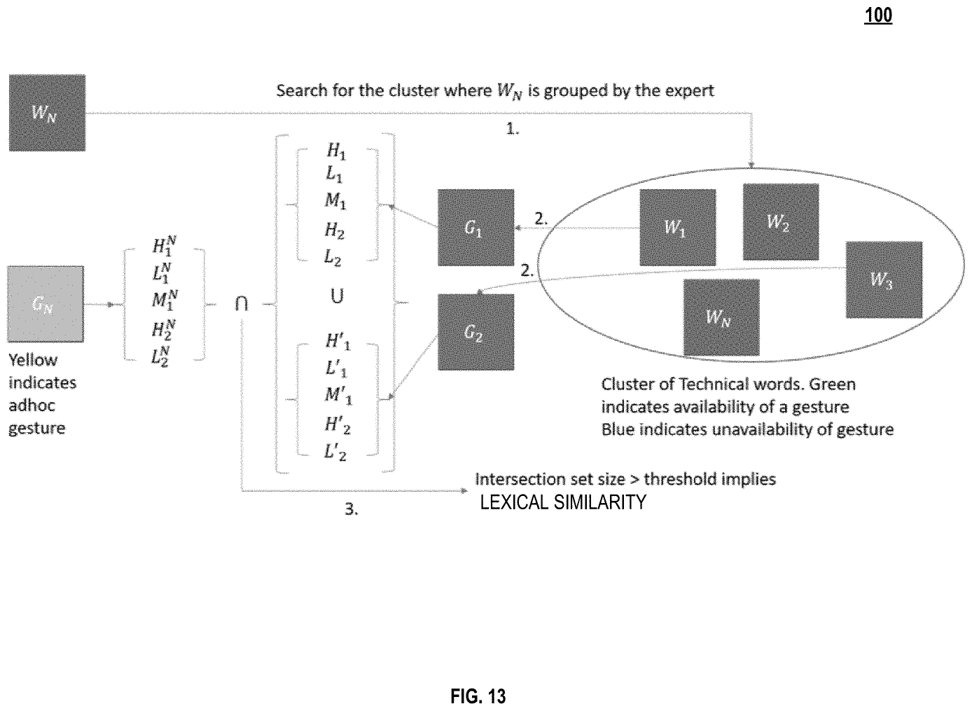

As shown in FIG. 13, given a gesture G_{N} for a word W_{N}, the system 100 can express the gesture in terms of handshapes (H_{N}), locations (L_{N}), and movements (M_{N}).

From the gesture node set, the system 100 can identify groupings of gesture nodes that have common handshapes, locations and movements. For each common concept, a gesture edge between a gesture node indicative of the gesture G_{N} and another gesture node in the gesture node set is established. The processor 120 can then apply a graph clique extraction methodology to derive a congruent clique (e.g., a nearest grouping) for the gesture node indicative of the gesture G_{N}. The likelihood of the gesture G_{N} belonging to a given clique is measured using the degree of the gesture G_{N} in the clique.

### 6. Examining Lexical Similarity of New Gestures

The system 100 can be employed to examine lexical similarity of new gestures with existing gestures within the gesture network graph.

The system 100 can associate each respective node in the gesture network graph with a recorded gesture representation indicative of a gesture of the gesture-based language. The gesture can be represented as gesture data that is captured during execution of the gesture and stored in a memory in communication with the processor 120. The recorded gesture representation can include raw gesture data, and/or can include a set of extracted lexical features that represent various lexical aspects of the gesture, including hand-shape, location, and movement of the gesture. In some embodiments, each node in the gesture network graph can also be associated with additional lexical or linguistic data, such as written-language counterparts, concepts, themes, definitions, a type of word or phrase (which can include parts of speech such as nouns, adjectives, verbs, etc., and can also include a type of gesture such as structural or functional). As such, the gesture network graph of the system 100 can be considered as a corpus for existing gestures, including recorded gesture representations, lexical/linguistic data, and relationships with other gestures.

To evaluate lexical similarity of a new gesture with related gestures defined within the gesture network graph, the processor 120 can receive gesture data indicative of execution of the new gesture, extract lexical features of the new gesture, and compare the lexical features of the new gesture with lexical features of one or more recorded gesture representations within the gesture network graph. By comparing lexical features of the new gesture with those of related gestures within the gesture network graph, the system 100 can assess lexical similarity of the new gesture with respect to related gestures.

Further, by comparing the gesture network graph including the new gesture with the word network graph including an equivalent written-language representation of the word, the processor 120 can assess whether the new gesture is consistent with the word. If the gesture node representative of the gesture data within the gesture network graph is close in proximity to an equivalent word node and/or one or more related word nodes within the word gesture, then the gesture expressed by the gesture data can be considered lexically similar to other gestures for words of similar meaning.

In one aspect, the system 100 can maintain the gesture network graph within a database 250 within the memory 140 in communication with the processor 120 of the system 100 or the database 250 and gesture network graph can be otherwise accessible by the processor 120 of the system 100. As discussed above, the gesture network graph can include the plurality of gesture nodes connected by gesture edges, where each respective gesture node of the plurality of gesture nodes of the gesture network graph is associated with a unique recorded gesture representation indicative of a gesture. Each respective gesture node can also be associated with lexical or linguistic information such as written-language equivalent information, context or theme information, definition information, and type of word or phrase (such as part of speech or type of gesture, e.g., functional or structural). The gesture network graph can include one or more groupings of gesture nodes that share common themes and have lexical similarities to one another. In a further aspect, each recorded gesture representation can be in the form of raw data, and/or can include lexical feature data representative of the gesture in terms of location, handshape, and movement of the gesture. Each recorded gesture representation can be indicative of proper execution of a gesture of the gesture-based language, where each gesture of the gesture-based language is analogous to a written-language word or a written-language phrase.

To evaluate lexical similarity of a new gesture with respect to existing gestures defined within the gesture network graph, the processor 120 can receive gesture data indicative of the new gesture. This gesture data can be in the form of video data, or can be from other modalities such as Wi-Fi signal data that tracks motion; the gesture data is obtained by observing execution of the new gesture by an individual. The processor 120 can extract lexical features of the gesture data as discussed above in section 3.1, especially location, handshape, and movement of the gesture as observable through the gesture data.

Similar to the discussion in section 3.1, the processor 120 can compare the lexical features of the gesture data (for the new gesture) with lexical features of one or more recorded gesture representations to evaluate similarity of each respective lexical feature of the gesture data with respect to each respective lexical feature of the one or more recorded gesture representations.

The processor 120 can also evaluate lexical similarity of the lexical features of the gesture data for the new gesture with respect to the lexical features of the one or more recorded gesture representations based on the similarity evaluation between lexical features. In some embodiments, the system 100 can generate an adjacency matrix for each lexical feature (handshape, location and movement) that includes the new gesture, assigning “1”s to cells where the associated lexical features between two associated gesture nodes are sufficiently similar to one another and assigning “0”s to cells where the associated lexical features between two associated gesture nodes are not sufficiently similar to one another (or vice-versa, where “0”s can denote similarity and “1”s can denote dissimilarity.

The processor 120 can use the adjacency matrices to characterize the lexical similarity of the lexical features of the new gesture with the one or more recorded gesture representations, focusing on recorded gesture representations within the gesture that are related to the new gesture (e.g., that belong to the same or similar themes). The adjacency matrices and the lexical similarity metric defined in Eq. 1 can be used to identify whether the lexical features of the new gesture are congruent with lexical features of related gestures within the gesture network graph. This can include identifying a nearest grouping of recorded gesture representations within the gesture network graph that is most similar to the gesture data based on similarity of the lexical features of the gesture data with respect to each the lexical features of the one or more recorded gesture representations (i.e., identifying which “cluster” of gesture nodes that the new gesture is closest to), and can also include identifying one or more lexical features of the gesture data that is incongruent with one or more lexical aspects of a nearest grouping of recorded gesture representations. In another aspect, the system 100 can also identify if the new gesture is too similar to one or more recorded gesture representations within the gesture network graph. New gestures should be distinguishable from related gestures, but should follow similar lexical features of related gestures.

In some embodiments, the processor 120 can compare the locality, proximity, and/or clique of the new gesture within the gesture network graph with the locality, proximity, and/or clique of the associated word within the word network graph to assess lexical similarity of the new gesture with its intended meaning. This can be based on a theme, word, phrase, and/or definition associated with the gesture data for evaluation of lexical similarity of the gesture data with respect to the one or more recorded gesture representations, and can also include lexical or linguistic information such as part of speech or type of gesture (e.g., structural vs functional). The processor 120 can use the intent data to evaluate lexical similarity of the new gesture with existing gestures represented within the gesture network graph by identifying if the new gesture is or is not lexically congruent with an intended theme or grouping of gestures, and can use the information in the gesture network graph and the word network graph to provide feedback to a user regarding lexical similarity.

For instance, if the user is a designer with the intention of creating a new gesture, then the processor 120 can receive information indicating that the gesture data is intended to be used to check lexical similarity of a newly-designed gesture with other related phrases (as opposed to evaluating execution of an already existing gesture as discussed above in Section 3). The processor 120 can receive information that identifies what written-language word or phrase (including greater context and meaning of the phrase) the designer is trying to convey using the new gesture so that the processor 120 can check lexical similarity of the new gesture with related gestures and words to ensure that the new gesture “fits” within the general theme and function of the new gesture. For example, if the new gesture is intended to be a functional expression, then the new gesture would need to have a movement aspect to it similar to other functional gestures that follow a similar theme; alternatively, if the gesture is intended to be a structural expression, then the new gesture would need to have a hand shape and/or location that is similar to other structural gestures that follow a similar theme.

As such, the system 100 can be configured to provide feedback to the user about lexical similarity of the new gesture with the intended meaning and/or associated word of the new gesture, including information about lexical similarity with other existing gestures related to the new gesture. For example, if the new gesture is intended to be a functional expression related to a particular theme, then the processor 120 can provide feedback about whether the lexical features of the new gesture are consistent with lexical features of other gestures within the network that are associated with the theme and whether the lexical features of the new gesture are consistent with other functional expressions. The processor 120 can generate the feedback information indicative of lexical similarity of the set of lexical features of the gesture data with respect to the set of lexical features of the one or more recorded gesture representations.

Following lexical similarity evaluation of the new gesture with respect to other gestures represented within the gesture network graph, the system 100 can display, at the display device 130 in communication with the processor 120, feedback information indicative of similarity and lexical similarity of the gesture data (of the new gesture) with respect to the one or more recorded gesture representations (indicative of existing gestures within the gesture network graph.

### 7. Validation Methodology for Lexical Similarity Extraction

The lexical similarity metric is tested using regular everyday use ASL gestures that are used widely and can be considered standard. Two sets of such videos are collected. With the first set of videos, a word-gesture network graph (which can include a gesture network graph and a word network graph as described above) is constructed for use within the system 100 based on manual observation and automated identification. The lexical similarity metric is then tested out on a second set of gesture videos as discussed in the following subsections.

7.1 Generation of Word Gesture Network Graph

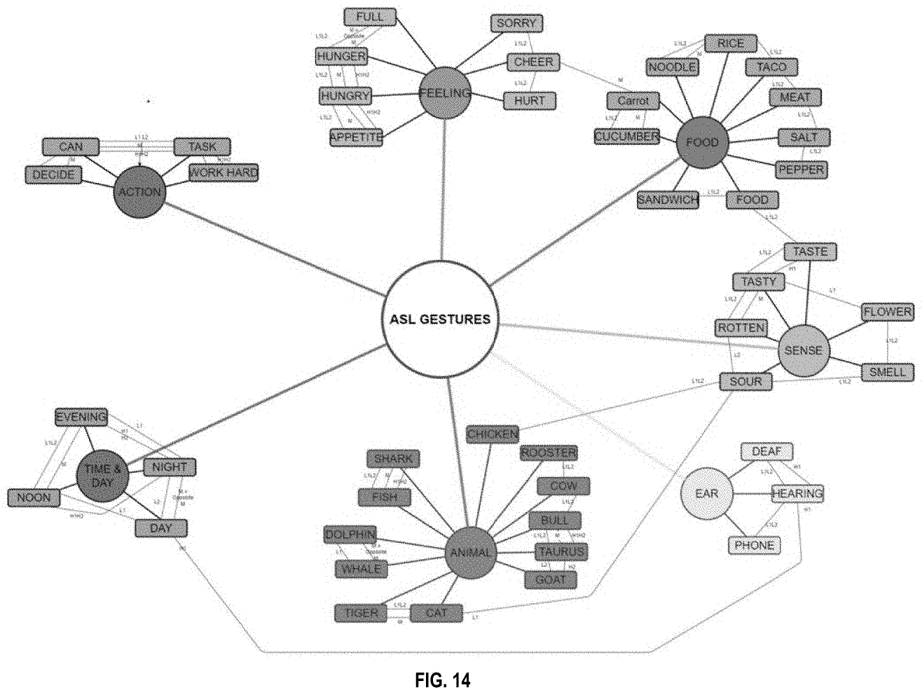

With the first set of videos, the videos are first grouped based on a common theme for the gestures. For example, gestures for “deaf”, “hearing” and “phone” are grouped in a category named “Ear”. The word-gesture network graph is then developed using commonalities identified between the ASL gestures for different words. The word-gesture network graph connects words that have common execution of concepts in their ASL gestures. For validation, two different word-gesture network graphs are developed based on—1) manual observation by an ASL user, as shown in FIG. 14, and 2) automated identification through machine learning techniques applied by the processor 120 as previously shown in FIG. 12.

Manual Observation Gesture network graph: For manual observation, an ASL user is brought in to observe the gesture executions and identify the common concepts between any two gestures in each group. In some cases, common location, handshape and movement are also identified across groups. Each gesture edge connecting two gestures represent a common gesture concept executed, L₁/L₂ for Location, H₁/H₂ for Handshape and M for Movement.

Automated Identification Gesture network graph: For validating automated identification by the system 100, results obtained from Location, Handshape and Movement recognition are used to develop the word-gesture network graph. For recognition of each of these concepts, the system 100 obtains keypoints from gesture data for each gesture execution. The keypoints are the body parts that are tracked frame by frame throughout the video. Keypoint estimation is necessary to identify the location, movement and handshape of the gesture execution. In one implementation example, the processor 120 collects keypoints for eyes, nose, shoulder, elbows and wrists using PoseNet.

Location Recognition: The system 100 considers start and end locations of the hand position for pose estimation, and identifies wrist joint positions frame by frame from a video of ASL gesture execution in a 2D space for key points. The two axes namely X-axis (the line that connects the two shoulder joints) and Y-axis (perpendicular to the x-axis) are drawn based on the shoulders of the signer as a fixed reference. The video canvas is divided into a plurality of different buckets (in one example implementation, 6 buckets). Then, as the ASL user executes any given sign, the buckets are identified for the starting and ending location of the handshape. Location labels obtained from the system 100 are then used to connect different gestures on the automated word gesture network graph. Gestures with common location for the start or end of the hand position are connected through an edge (labeled L for location) between them, irrespective of their theme groups.

Movement Recognition: The system 100 considers hand movement type by capturing the movement of the hands with respect to time from its start to the end of the sign. They are matched with a list of pre-defined standard movements and matching labels are obtained. Gestures with same label are then connected with an edge between them (labeled M for movement).

Handshape Recognition: ASL signs differ lexically by the shape or orientation of the hands. To ensure focused handshape recognition, the system 100 requires a tight crop of each of the hands using the wrist position for different videos. The system 100 uses the wrist location as a guide to auto-crop these handshape images and matches cropped images against each other. The system 100 obtains a similarity matrix, and uses a similarity threshold to identify gestures that have similar handshapes; in one example implementation, the similarity threshold can be 0.73 (73% matching). The system 100 draws edges between them to connect these gestures (labeled H for handshape).

7.2 Adjacency Matrix Creation

The processor 120 creates adjacency matrices for Location, Movement and Handshape using the location, movement and handshape edges that connect each gesture node in the word-gesture network graph. The system 100 uses a location adjacency matrix for location, where cell value 1 is entered for gesture nodes with same location in manual observation. Gesture nodes that do not have a location edge connecting them, share a cell value of 0. Same matrix size and process is followed for a movement adjacency matrix and a handshape adjacency matrix, resulting in three different adjacency matrices to describe lexical connections between gesture nodes.

For validation, the location adjacency matrix, the movement adjacency matrix and the handshape adjacency matrix obtained by the system 100 were compared with a location adjacency matrix, a movement adjacency matrix and a handshape adjacency matrix that were obtained through manual labelling.

The processor 120 can then calculate the lexical similarity ω, as shown in Eqn 2 in Sec 5.2.3. Individual scores were found for handshape, location, movement and then overall similarity, ω, for two sets of gestures (regular and animal). The results of these calculations are discussed in detail in Sec 7.3.

7.3 Results: Validation of Similarity Metric

This section first shows whether the lexical similarity metric can be used in an automated similarity check mechanism such as that employed by the system 100, and also shows that the lexical similarity metric is capable of capturing similarity with action and structure gestures.

Automated Similarity Check: The lexical similarity metric is computed for the Gesture network graphs discussed above in Sec 7.1. In addition, a second set of 32 videos for animal gestures are examined. This new data set is used in this phase to test the lexical similarity metric. A manually-derived animal gesture network graph is first created based on manually observed similarities in the gestures. The system 100 is then applied to the second set to obtain an automatically-derived animal gesture network graph using the process described earlier and collect the location labels, movement and handshape matrices. The gesture nodes are connected by gesture edges if they have same location labels. Using the movement and handshape matrices, the similar movement and handshapes are also identified. A similarity threshold of 0.73 (=73% similarity) is selected for hand shapes to be considered similar. Gesture nodes with similar movements and handshapes are then connected by gesture edges. Six adjacency matrices are built for this data set following the process described in Sec 7.2.

For each network (e.g., the regular gesture network graph and the animal gesture network graph), the lexical similarity score is computed using the manually-obtained adjacency matrices and the system-obtained adjacency matrices.

Here, a lower score represents higher similarity between the manual and the automated gesture network graphs, e.g., a movement similarity score of 0 would mean that manually-observed and system-identified movements in the gestures were the same, and movement similarity score of 1 would mean that manual observation and automated identification of movements in the gestures were different. While computing the congruities for each of the concepts, scores are expected to be in between 0 to 1. And by adding these individual congruities, the overall similarity score, ω, is expected to be in between 0 to 3.

The handshape, location and movement similarity scores are also compared between regular gestures and animal gestures. Table 3 shows the computed lexical similarity scores, as discussed in Eqn 2.

TABLE 3

| | Handshape | Location | Movement | Overall |
|---|---|---|---|---|
| Network | Congruity | Congruity | Congruity | Congruity |
| Regular Gestures | 0.71 | 0.09 | 0.27 | 1.07 |
| Animal Specific | 0.65 | 0.04 | 0.3 | 0.99 |
| Gestures | | | | |
| Regular Gestures | 0.96 | 0.7 | 0.8 | 2.46 |
| Vs | | | | |
| Animal Specific | | | | |
| Gestures | | | | |

The results show that with respect to location and movement, the automated recognition mechanism of the system 100 can capture the lexical relations between the words. This is reflected in the low values of the lexical similarity score for each of these concepts. However, for handshape, the result is poorer than location and movement. This is understandable given that, there were several gestures where manual identification labeled some handshapes as being similar even when they were used in different orientation and rotated in a different way. Initial implementations of the system 100 were not trained to consider the rotated handshapes in different orientations; as such, in some embodiments, the system 100 can be configured to identify handshapes regardless of rotation.

In the comparison between the concepts of regular gestures and animal specific gestures, one can see a higher similarity value—which is reflective of the fact that there is significant difference between the concepts of regular gestures and the concepts of animal gestures (as one would expect for different set of words with different meanings).

Evaluating similarity with action: In this experiment, a set of 45 gestures are divided into two classes: a) action or functional gestures (n=25) and structural gestures (n=20). Ten action gestures are randomly selected from the action set, which includes the test set. For each action gesture in the test set, the clique extraction algorithm of the system 100 is employed to determine whether the gesture is more likely to be a member of an action gesture clique or a structure gesture clique. As a measure of likelihood of belonging to a clique, the system 100 computes the degree, (i.e., the number of gesture edges) connecting the test gesture to any other gesture node in the clique. A 10 fold cross validation approach is then applied, where ten different sets of ten action gestures (with replacement) were selected from the set of 25. It is observed that on an average the action gestures from the test set had a greater degree by 1.95 (SD: 1.25, p value: 0.0008) in the action clique than in the structure clique. This indicates that the lexical similarity checking algorithm of the system 100 can distinguish between action gestures and structure gestures.

### 8. Envisioned Framework for Accessible Technical Education:

With reference to FIG. 15, the lexical similarity metric described above can be used by the system 100 to aid DHH learners in building a corpus of standardized gestures for technical terms. This will not only help in recognizing complex concepts faster but will also help in sharing knowledge among DHH or hearing peers. In one aspect, the system 100 can use a database of video examples of a subset of the ASL corpus as available in ASL online repositories and CS technical terms. When a DHH individual and an interpreter come across a word such as a technical term, they can use a search functionality of the system 100 to check for the existence of a standard sign. There may be three outcomes for this search:

No available sign: The DHH individual and the interpreter can collaborate to develop a new sign for the word, can video record a few examples of the technical sign (e.g., as gesture data) and can upload the gesture data to a server or a memory in communication with a processor of a computing device used for implementation of the system 100. The processor 120 then applies a concept extraction algorithm to extract concepts from the gesture in the form of a set of lexical features of the gesture and the word. The processor 120 then applies a concept matching algorithm that evaluates a lexical similarity between the gesture data (represented as having a place in the gesture network graph based on the lexical gestures) and the word (represented as having a place in the word network graph) in terms of a similarity score; this step can involve identifying a locality, proximity, cluster or clique within the gesture network graph that the gesture data “falls” into. The processor 120 can then provide feedback to users by identifying one or more lexical concepts in the technical term that have poor similarity with other related gestures (identified as being related based on proximity or locality within the gesture network graph) is then used to suggest changes to the gesture that can be made to improve similarity. In subsequent iterations, when the lexical similarity score crosses a lexical similarity threshold, then the new gesture can be used as a standard gesture for the word.

Few example signs are available: The DHH student and the Interpreter can either propose a new gesture (for this option, process in outcome (a) will be followed), or select from one or more example signs that are candidates for standard signs. A “most selected gesture” by all learners reaches a threshold number of usages, could be considered as a standard gesture for the word.

An available standard sign exists: The processor 120 can compare gesture data representative of execution of the gesture as signed by the DHH student and/or the interpreter (or, more generally, a learner or user) with one or more recorded gesture representations for the specific word or gesture to learn the proper execution of the sign.

### 9. Methods

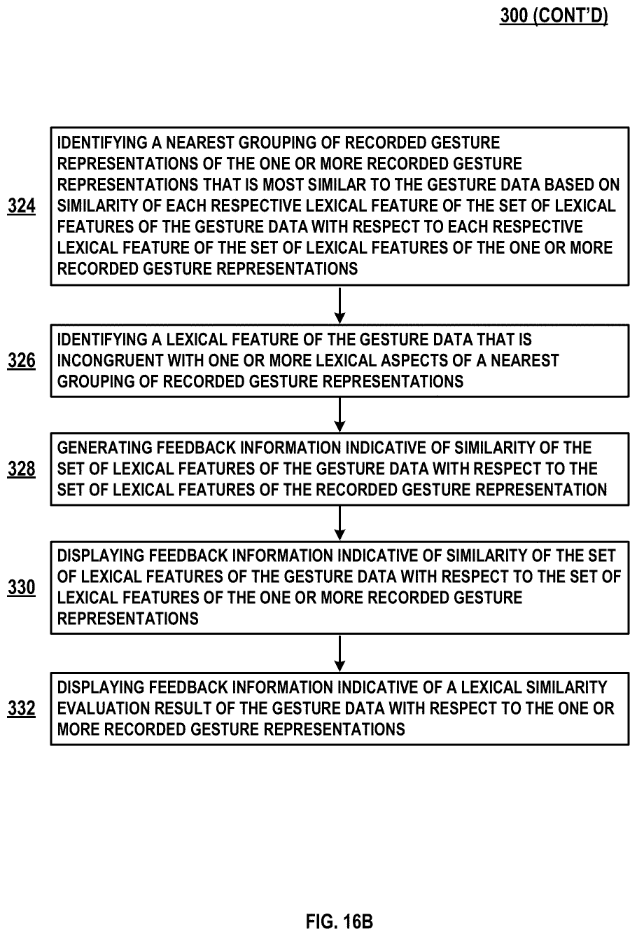

FIGS. 16A and 16B illustrate a method 300 for gesture evaluation by the system 100 of FIGS. 1-15.

At block 310, the method 300 includes receiving gesture data indicative of a gesture. At block 312, the method 300 includes receiving information indicative of a written-language word associated with the gesture represented within the gesture data. Depending on whether the system 100 is being used to evaluate execution of the gesture or to evaluate a new gesture, the information can indicate whether the gesture data is associated with a new word or an existing gesture.

At block 314, the method 300 includes retrieving a set of lexical features of a recorded gesture representation for comparison with the gesture data associated with the written-language word. If the system 100 is being used to evaluate gesture execution, the recorded gesture representation can be directly associated with the written-language word and serves as an example to check execution of the gesture; alternatively, if the system 100 is being used to evaluate a new gesture, the recorded gesture representation can be one of a plurality of recorded gesture representations that directly are related to the written-language word and serves as an example to check lexical similarity of the new gesture with related existing gestures.

At block 316, the method 300 includes extracting a set of lexical features of the gesture, the set of lexical features including a set of handshape features of the gesture data, a set of movement features of the gesture data, and a set of location features of the gesture data. At block 318, the method 300 includes comparing each respective lexical feature of the gesture data with respect to each respective lexical feature of the set of lexical features of the recorded gesture representation.

At block 320, the method 300 includes evaluating similarity of each respective lexical feature of the set of lexical features of the gesture data with respect to each respective lexical feature of a set of lexical features of one or more recorded gesture representations of a gesture-based language. This step is performed regardless of whether the system 100 is being used for evaluating execution of the gesture or for evaluating a new gesture. At block 322, the method includes evaluating lexical similarity of the gesture data with respect to the one or more recorded gesture representations based on similarity of each respective lexical feature of the gesture data with respect to each respective lexical feature of the one or more recorded gesture representations. The system 100 applies this step to evaluate the lexical similarity of new gestures as a whole with other related gestures.

At block 324, the method 300 includes identifying a nearest grouping of recorded gesture representations of the one or more recorded gesture representations that is most similar to the gesture data based on similarity of each respective lexical feature of the set of lexical features of the gesture data with respect to each respective lexical feature of the set of lexical features of the one or more recorded gesture representations. The system 100 applies this step to determine a locality, position, or clique of a new gesture with respect to other related gestures, particularly within the gesture network.

At block 326, the method 300 includes identifying a lexical feature of the gesture data that is incongruent with one or more lexical aspects of a nearest grouping of recorded gesture representations. The system 100 applies this step to provide actionable feedback about new gestures, particularly to show users what improvements or changes could be made to the new gesture to ensure that the new gesture is lexically similar enough to related gestures.

At block 328, the method 300 includes generating feedback information indicative of similarity of the set of lexical features of the gesture data with respect to the set of lexical features of the recorded gesture representation. The system 100 applies this step for both evaluating gesture execution and evaluating new gestures.

At block 330, the method 300 includes displaying feedback information indicative of similarity of the set of lexical features of the gesture data with respect to the set of lexical features of the one or more recorded gesture representations. The system 100 applies this step for both evaluating gesture execution and evaluating new gestures. At block 332, the method 300 includes displaying feedback information indicative of a lexical similarity evaluation result of the gesture data with respect to the one or more recorded gesture representations. The system 100 can apply this step to provide feedback for new gestures as a whole following evaluation of lexical similarity with respect to existing gestures.

### 10. Computing Device

FIG. 17 is a schematic block diagram of an example computing device 102 that may be used with one or more embodiments described herein, e.g., as a component of the system.

Computing device 102 comprises one or more network interfaces 110 (e.g., wired, wireless, PLC, etc.), at least one processor 120 in communication with the display device 130, and the memory 140 interconnected by a system bus 150, as well as a power supply 160 (e.g., battery, plug-in, etc.).

Network interface(s) 110 include the mechanical, electrical, and signaling circuitry for communicating data over the communication links coupled to a communication network. Network interfaces 110 are configured to transmit and/or receive data using a variety of different communication protocols. As illustrated, the box representing network interfaces 110 is shown for simplicity, and it is appreciated that such interfaces may represent different types of network connections such as wireless and wired (physical) connections. Network interfaces 110 are shown separately from power supply 160, however it is appreciated that the interfaces that support PLC protocols may communicate through power supply 160 and/or may be an integral component coupled to power supply 160.

Memory 140 includes a plurality of storage locations that are addressable by processor 120 and network interfaces 110 for storing software programs and data structures associated with the embodiments described herein. In some embodiments, computing device 102 may have limited memory or no memory (e.g., no memory for storage other than for programs/processes operating on the device and associated caches).

Processor 120 comprises hardware elements or logic adapted to execute the software programs (e.g., instructions) and manipulate data structures 145. An operating system 142, portions of which are typically resident in memory 140 and executed by the processor, functionally organizes computing device 102 by, inter alia, invoking operations in support of software processes and/or services executing on the device. These software processes and/or services may include or enable gesture evaluation processes/services 190 described herein. Note that gesture evaluation processes/services 190 is illustrated in centralized memory 140, alternative embodiments provide for the process to be operated within the network interfaces 110, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the gesture evaluation processes/services 190 is shown as a standalone process, those skilled in the art will appreciate that this process may be executed as a routine or module within other processes.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto

What is claimed is:

1. A method, comprising:
receiving, at a processor in communication with a memory, gesture data indicative of a gesture;
extracting, at the processor, a set of lexical features of the gesture, the set of lexical features including a set of handshape features of the gesture data, a set of movement features of the gesture data, and a set of location features of the gesture data;
evaluating, at the processor, similarity of each respective lexical feature of the set of lexical features of the gesture data with respect to each respective lexical feature of a set of lexical features of one or more recorded gesture representations of a gesture-based language; and
displaying, at a display device in communication with the processor, feedback information indicative of similarity of the set of lexical features of the gesture data with respect to the set of lexical features of the one or more recorded gesture representations.

2. The method of claim 1, further comprising:
evaluating, at the processor, lexical similarity of the gesture data with respect to the one or more recorded gesture representations based on similarity of each respective lexical feature of the gesture data with respect to each respective lexical feature of the one or more recorded gesture representations; and
displaying, at the display device, feedback information indicative of a lexical similarity evaluation result of the gesture data with respect to the one or more recorded gesture representations.

3. The method of claim 2, further comprising:
identifying a nearest grouping of recorded gesture representations of the one or more recorded gesture representations that is most similar to the gesture data based on similarity of each respective lexical feature of the set of lexical features of the gesture data with respect to each respective lexical feature of the set of lexical features of the one or more recorded gesture representations.

4. The method of claim 2, further comprising:
identifying a lexical feature of the gesture data that is incongruent with one or more lexical aspects of a nearest grouping of recorded gesture representations.

5. The method of claim 1, wherein each recorded gesture representation is indicative of proper execution of a gesture of the gesture-based language, wherein each gesture of the gesture-based language is analogous to a written-language word or a written-language phrase.

6. The method of claim 1, further comprising:
receiving, at the processor, information indicative of a written-language word associated with the gesture represented within the gesture data;
retrieving, at the processor, a set of lexical features of a recorded gesture representation for comparison with the gesture data associated with the written-language word;
comparing, at the processor, each respective lexical feature of the gesture data with respect to each respective lexical feature of the set of lexical features of the recorded gesture representation; and
generating the feedback information indicative of similarity of the set of lexical features of the gesture data with respect to the set of lexical features of the recorded gesture representation.

7. The method of claim 1, wherein the one or more recorded gesture representations are each represented as gesture nodes within a gesture network graph accessible by the processor, wherein associations of each respective gesture node in the gesture network graph are represented by a handshape adjacency matrix, a location adjacency matrix, and a movement adjacency matrix, and wherein the gesture network graph includes one or more groupings of gesture nodes, where each respective grouping of gesture nodes of the one or more groupings of gesture nodes includes one or more gesture nodes associated with a common theme and having one or more common lexical features across the one or more gesture nodes.

8. The method of claim 7, where the handshape adjacency matrix denotes similarity or non-similarity of a handshape associated with each respective gesture node in the gesture network graph with respect to one another.

9. The method of claim 7, where the location adjacency matrix denotes similarity or non-similarity of a location associated with each respective gesture node in the gesture network graph with respect to one another.

10. The method of claim 7, where the movement adjacency matrix denotes similarity or non-similarity of a movement associated with each respective gesture node in the gesture network graph with respect to one another.

11. A system, comprising:
a processor in communication with a memory, the memory including instructions, which, when executed, cause the processor to:
receive, at the processor, gesture data indicative of a gesture;
extract, at the processor, a set of lexical features of the gesture, the set of lexical features including a set of handshape features of the gesture data, a set of movement features of the gesture data, and a set of location features of the gesture data;
evaluate, at the processor, similarity of each respective lexical feature of the set of lexical features of the gesture data with respect to each respective lexical feature of a set of lexical features of one or more recorded gesture representations of a gesture-based language; and
display, at a display device in communication with the processor, feedback information indicative of similarity of the set of lexical features of the gesture data with respect to the set of lexical features of the one or more recorded gesture representations.

12. The system of claim 11, the memory further including instructions, which, when executed, cause the processor to:
evaluate, at the processor, lexical similarity of the gesture data with respect to the one or more recorded gesture representations based on similarity of each respective lexical feature of the gesture data with respect to each respective lexical feature of the one or more recorded gesture representations; and
display, at the display device, feedback information indicative of a lexical similarity evaluation result of the gesture data with respect to the one or more recorded gesture representations.

13. The system of claim 11, the memory further including instructions, which, when executed, cause the processor to:
identify a nearest grouping of recorded gesture representations of the one or more recorded representations that is most similar to the gesture data based on similarity of each respective lexical feature of the set of lexical features of the gesture data with respect to each respective lexical feature of the set of lexical features of the one or more recorded gesture representations.

14. The system of claim 11, the memory further including instructions, which, when executed, cause the processor to:
identify a lexical feature of the gesture data that is incongruent with one or more lexical aspects of a nearest grouping of recorded gesture representations.

15. The system of claim 11, the memory further including instructions, which, when executed, cause the processor to:
receiving, at the processor, information indicative of a written-language word associated with the gesture represented within the gesture data;
retrieving, at the processor, a set of lexical features of a recorded gesture representation for comparison with the gesture data associated with on the written-language word;
comparing, at the processor, each respective lexical feature of the gesture data with respect to each respective lexical feature of the set of lexical features of the recorded gesture representation; and
generating the feedback information indicative of similarity of the set of lexical features of the gesture data with respect to the set of lexical features of the recorded gesture representation.

16. The system of claim 11, wherein the one or more recorded gesture representations are each represented as gesture nodes within a gesture network graph accessible by the processor, wherein associations of each respective gesture node in the gesture network graph are represented by a handshape adjacency matrix, a location adjacency matrix, and a movement adjacency matrix, and wherein the gesture network graph includes one or more groupings of gesture nodes, where each respective grouping of gesture nodes of the one or more groupings of gesture nodes includes one or more gesture nodes associated with a common theme and having one or more common lexical features across the one or more gesture nodes.

17. The system of claim 16, where the handshape adjacency matrix denotes similarity or non-similarity of a handshape associated with each respective gesture node in the gesture network graph with respect to one another.

18. The system of claim 16, where the location adjacency matrix denotes similarity or non-similarity of a location associated with each respective gesture node in the gesture network graph with respect to one another.

19. The system of claim 16, where the movement adjacency matrix denotes similarity or non-similarity of a movement associated with each respective gesture node in the gesture network graph with respect to one another.

20. The system of claim 11, wherein each recorded gesture representation is indicative of proper execution of a gesture of the gesture-based language, wherein each gesture of the gesture-based language is analogous to a written-language word or a written-language phrase.
